(19) United States
(12) Patent Application Publication
(10) Pub. No.: US 2026/0362431 A1
(43) Pub. Date: Nov. 12, 2026

(54) USER EQUIPMENT AUTONOMOUS UPLINK TRANSMISSION BASED ON ARTIFICIAL INTELLIGENCE/MACHINE LEARNING MODELING

(71) Applicant: QUALCOMM Incorporated, San Diego, CA (US)

(72) Inventors: Yi HUANG, San Diego, CA (US); Taesang YOO, San Diego, CA (US); Himanshu JOSHI, San Jose, CA (US); Ziqi WANG, San Diego, CA (US)

(21) Appl. No.: 19/201,675

(22) Filed: May 7, 2025

(51) Int. Cl. H04W 72/21; H04L 41/16; H04W 72/115

(52) U.S. Cl. CPC H04W 72/21; H04L 41/16; H04W 72/115

(57) ABSTRACT

This disclosure provides methods, components, devices and systems for user equipment (UE) autonomous uplink transmission based on artificial intelligence/machine learning (AI/ML) modeling. For example, the UE may receive information that identifies a threshold level corresponding to a probability of success for an autonomous physical uplink shared channel (PUSCH) transmission by the UE. The UE may receive a configuration signal that identifies one or more configured grant (CG)-PUSCH configurations, each CG-PUSCH configuration comprising a set of CG-PUSCH transmission occasions available for performing autonomous PUSCH transmissions by the UE. The UE may transmit at least one autonomous PUSCH transmission during a first CG-PUSCH transmission occasion or during a second CG-PUSCH transmission occasion based at least in part on the threshold level and the probability of success associated with the first CG-PUSCH transmission occasion.

### TECHNICAL FIELD

This disclosure relates generally to wireless communication, and more specifically to systems, devices, methods, and techniques associated with user equipment autonomous uplink transmission based on artificial intelligence/machine learning modeling.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communications by a user equipment (UE) is described. The method may include receiving information that identifies a threshold level corresponding to a probability of success for an autonomous physical uplink shared channel (PUSCH) transmission by the UE, receiving a configuration signal that identifies one or more configured grant (CG)-PUSCH configurations, each CG-PUSCH configuration including a set of CG-PUSCH transmission occasions available for performing autonomous PUSCH transmissions by the UE, and transmitting at least one autonomous PUSCH transmission during a first CG-PUSCH transmission occasion or during a second CG-PUSCH transmission occasion based on the threshold level and the probability of success associated with the first CG-PUSCH transmission occasion.

A UE for wireless communications is described. The UE may include a processing system that includes processor circuitry and memory circuitry that stores code. The processing system may be configured to cause the UE to receive information that identifies a threshold level corresponding to a probability of success for an autonomous PUSCH transmission by the UE, receive a configuration signal that identifies one or more CG-PUSCH configurations, each CG-PUSCH configuration including a set of CG-PUSCH transmission occasions available for performing autonomous PUSCH transmissions by the UE, and transmit at least one autonomous PUSCH transmission during a first CG-PUSCH transmission occasion or during a second CG-PUSCH transmission occasion based on the threshold level and the probability of success associated with the first CG-PUSCH transmission occasion.

Another UE for wireless communications is described. The UE may include means for receiving information that identifies a threshold level corresponding to a probability of success for an autonomous PUSCH transmission by the UE, means for receiving a configuration signal that identifies one or more CG-PUSCH configurations, each CG-PUSCH configuration including a set of CG-PUSCH transmission occasions available for performing autonomous PUSCH transmissions by the UE, and means for transmitting at least one autonomous PUSCH transmission during a first CG-PUSCH transmission occasion or during a second CG-PUSCH transmission occasion based on the threshold level and the probability of success associated with the first CG-PUSCH transmission occasion.

A non-transitory computer-readable medium storing code for wireless communications is described. The code may include instructions executable by one or more processors to receive information that identifies a threshold level corresponding to a probability of success for an autonomous PUSCH transmission by the UE, receive a configuration signal that identifies one or more CG-PUSCH configurations, each CG-PUSCH configuration including a set of CG-PUSCH transmission occasions available for performing autonomous PUSCH transmissions by the UE, and transmit at least one autonomous PUSCH transmission during a first CG-PUSCH transmission occasion or during a second CG-PUSCH transmission occasion based on the threshold level and the probability of success associated with the first CG-PUSCH transmission occasion.

Some examples of the method, user equipment (UEs), and non-transitory computer-readable medium described herein may further include operations, features, means, or instructions for applying a learning model to determine the probability of success associated with the first CG-PUSCH transmission occasion, where the at least one autonomous PUSCH transmission may be performed during the first CG-PUSCH transmission occasion based on an output of the learning model satisfying the threshold level or during the second CG-PUSCH transmission occasion based on the output of the learning model failing to satisfy the threshold level.

In some examples of the method, user equipment (UEs), and non-transitory computer-readable medium described herein, one or more inputs to the learning model include one or more previous channel performance metrics, one or more interference metrics, a prior PUSCH transmission success rate, a prior physical downlink shared channel (PDSCH) success rate, or any combination thereof, during a set of slots occurring prior to a slot containing the first CG-PUSCH transmission occasion.

In some examples of the method, user equipment (UEs), and non-transitory computer-readable medium described herein, the learning model includes at least one of a neural network (NN) learning model, a convolution NN (CNN) learning model, a recurrent NN (RNN) learning model, an artificial intelligence (AI) learning model, or any combination thereof.

A method for wireless communications by a network entity is described. The method may include transmitting, to a UE, information that identifies a threshold level corresponding to a probability of success for an autonomous PUSCH transmission by the UE, transmitting, to the UE, a configuration signal that identifies one or more CG-PUSCH configurations, each CG-PUSCH configuration including a set of CG-PUSCH transmission occasions available for performing autonomous PUSCH transmissions by the UE, and receiving, from the UE, at least one autonomous PUSCH transmission during a first CG-PUSCH transmission occasion or during a second CG-PUSCH transmission occasion based on the threshold level and the probability of success associated with the first CG-PUSCH transmission occasion.

A network entity for wireless communications is described. The network entity may include a processing system that includes processor circuitry and memory circuitry that stores code. The processing system may be configured to cause the network entity to transmit, to a UE, information that identifies a threshold level corresponding to a probability of success for an autonomous PUSCH transmission by the UE, transmit, to the UE, a configuration signal that identifies one or more CG-PUSCH configurations, each CG-PUSCH configuration including a set of CG-PUSCH transmission occasions available for performing autonomous PUSCH transmissions by the UE, and receive, from the UE, at least one autonomous PUSCH transmission during a first CG-PUSCH transmission occasion or during a second CG-PUSCH transmission occasion based on the threshold level and the probability of success associated with the first CG-PUSCH transmission occasion.

Another network entity for wireless communications is described. The network entity may include means for transmitting, to a UE, information that identifies a threshold level corresponding to a probability of success for an autonomous PUSCH transmission by the UE, means for transmitting, to the UE, a configuration signal that identifies one or more CG-PUSCH configurations, each CG-PUSCH configuration including a set of CG-PUSCH transmission occasions available for performing autonomous PUSCH transmissions by the UE, and means for receiving, from the UE, at least one autonomous PUSCH transmission during a first CG-PUSCH transmission occasion or during a second CG-PUSCH transmission occasion based on the threshold level and the probability of success associated with the first CG-PUSCH transmission occasion.

A non-transitory computer-readable medium storing code for wireless communications is described. The code may include instructions executable by one or more processors to transmit, to a UE, information that identifies a threshold level corresponding to a probability of success for an autonomous PUSCH transmission by the UE, transmit, to the UE, a configuration signal that identifies one or more CG-PUSCH configurations, each CG-PUSCH configuration including a set of CG-PUSCH transmission occasions available for performing autonomous PUSCH transmissions by the UE, and receive, from the UE, at least one autonomous PUSCH transmission during a first CG-PUSCH transmission occasion or during a second CG-PUSCH transmission occasion based on the threshold level and the probability of success associated with the first CG-PUSCH transmission occasion.

Some examples of the method, network entities, and non-transitory computer-readable medium described herein may further include operations, features, means, or instructions for transmitting, to the UE, one or more inputs to be applied to a learning model, where the learning model may be applied to determine to perform the at least one autonomous PUSCH transmission during the first CG-PUSCH transmission occasion or during the second CG-PUSCH transmission occasion.

In some examples of the method, network entities, and non-transitory computer-readable medium described herein, the one or more inputs may be based on a channel whitening procedure, a channel impulse response (CIR), or any combination thereof.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

FIG. 1 shows an example of a wireless communication system.

FIG. 2 shows an example of a signaling diagram that supports user equipment (UE) autonomous uplink transmission based on artificial intelligence/machine learning (AI/ML) modeling.

FIGS. 3A and 3B show an example of an AI/ML neural network (NN) that supports UE autonomous uplink transmission based on AI/ML modeling.

FIG. 4 shows an example of an AI/ML NN that supports UE autonomous uplink transmission based on AI/ML modeling.

FIG. 5 shows an example of a diagram that supports UE autonomous uplink transmission based on AI/ML modeling.

FIG. 6 shows an example of a diagram that supports UE autonomous uplink transmission based on AI/ML modeling.

FIG. 7 shows an example of a diagram that supports UE autonomous uplink transmission based on AI/ML modeling.

FIG. 8 shows a block diagram of a processing system that supports UE autonomous uplink transmission based on AI/ML modeling.

FIG. 9 shows a diagram of a system including a device that supports UE autonomous uplink transmission based on AI/ML modeling.

FIG. 10 shows a block diagram of a processing system that supports UE autonomous uplink transmission based on AI/ML modeling.

FIG. 11 shows a diagram of a system including a device that supports UE autonomous uplink transmission based on AI/ML modeling.

FIGS. 12 and 13 show flowcharts illustrating methods that support UE autonomous uplink transmission based on AI/ML modeling.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communication systems, autonomous uplink transmissions performed by user equipment (UE) may be supported. For example, the UE may be configured with one or more Type 1 configured grant-physical uplink shared channel (CG-PUSCH) configurations. Each CG-PUSCH configuration may generally configure, identify, or otherwise indicate a set of uplink (UL) PUSCH transmission occasions that are available for use by the UE for the autonomous uplink transmissions. The CG-PUSCH configurations may be semi-statically configured for the UE via radio resource control (RRC) signaling. Unlike a Type 2 CG-PUSCH configuration where the uplink PUSCH transmission occasions are configured via the RRC signaling but activated or otherwise enabled via dynamic signaling (e.g., via a downlink control information (DCI) and/or medium access control-control element (MAC-CE) signaling), the Type 1 CG-PUSCH configuration uplink PUSCH transmission occasions are activated upon configuration and available for use by the UE autonomously (e.g., without further signaling from the network). However, such wireless networks may not provide a mechanism for the UE to determine if, and if so, which uplink PUSCH transmission occasion should be used for an uplink transmission.

Aspects of the subject matter described in this disclosure relate to adaptation of an artificial intelligence/machine learning (AI/ML) neural network (NN) at the UE that improves Type 1 CG-PUSCH-based uplink PUSCH transmission occasion use. For example, the UE may apply the AI/ML NN learning modeling to determine whether an upcoming PUSCH transmission occasions (e.g., the next PUSCH transmission occasion) should be used for the uplink transmission or whether the UE should wait for a later PUSCH transmission occasion to perform the uplink transmission. The inputs to the AI/M NN learning model may be based on previous channel observations or measurements, previous interference observations or measurements, previous PUSCH transmission acknowledgement/negative-acknowledgement (ACK/NACK) feedback, previous physical downlink control channel (PDCCH) transmissions received by the UE, or similar or related inputs, for the previous x slots, where x is a positive number. The AI/ML NN learning model may be applied in a rolling fashion for each upcoming PUSCH transmission occasion (e.g., a rolling window in the time domain that relates to the slot t with the next uplink PUSCH transmission occasion relative to the previous slots, such as t−1, t−2, . . . , associated with the previous observations, measurements, or feedback).

For example, the network entity may transmit (and the UE may receive) information that identifies a threshold level corresponding to a probability of success or an autonomous PUSCH transmission by the UE. That is, the network may configure a threshold level that is used according to the output of the AI/ML NN learning model (e.g., P, which refers to the probability of success and/or failure if the UE uses the next uplink PUSCH transmission occasion). The network may transmit (and the UE may receive) a configuration signal (e.g., RRC signaling) that identifies one or more CG-PUSCH configurations for the UE. As discussed, each CG-PUSCH configuration may define, identify, or otherwise include a set of CG-PUSCH transmission occasions (e.g., the uplink PUSCH transmission occasions) available for the UE to perform the autonomous PUSCH transmissions. The UE may transmit or otherwise perform at least one autonomous uplink transmission during a first CG-PUSCH transmission occasion (e.g., the next upcoming uplink PUSCH transmission occasion) or during a second CG-PUSCH transmission occasion (e.g., a later uplink PUSCH transmission occasion) based on the threshold level configured by the network and the probability of success and/or failure associated with the first CG-PUSCH transmission occasion. That is, the threshold level may be compared to the output of the AI/ML NN learning model to determine to perform the autonomous uplink transmission during the next upcoming uplink PUSCH transmission occasion or defer to a later uplink PUSCH transmission occasion.

Particular aspects of the subject matter described in this disclosure can be implemented to realize one or more of the following potential advantages. In some examples, by utilizing the AI/ML NN learning model, the described techniques can be used to improve the utilization efficiency of Type 1 CG-PUSCH configuration resources. Based on the network-configured threshold level, the output of the AI/ML NN learning model may provide an improved indication of the likelihood of success for the autonomous uplink transmission by the UE, which may improve uplink communications by the UE. The AI/ML NN learning model may be trained and updated in an ongoing basis to account for changing circumstances and/or conditions observed or otherwise measured by the UE, which provides on ongoing improvement in over-the-air resource usage and interference mitigation within the wireless network.

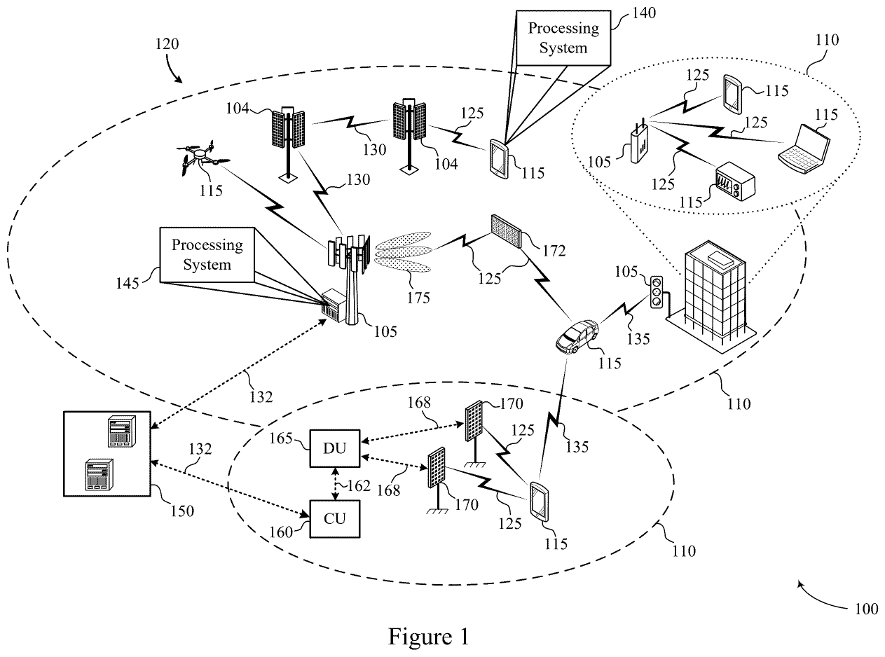

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access the services of other NFs.

UEs 115 may be located in a coverage area 110 of one or more network entities 105 and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHZ), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration) or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

Devices of the wireless communication system 100 may be configured to support one or more aspects of the described techniques for UE autonomous uplink transmission based on AI/ML modeling. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the wireless communication system 100 (such as the RAN 120) may support the implementation of an AI/ML NN learning model within, coupled with, and/or otherwise associated with the UE 115 to improve Type 1 CG-PUSCH resource usage and effectiveness.

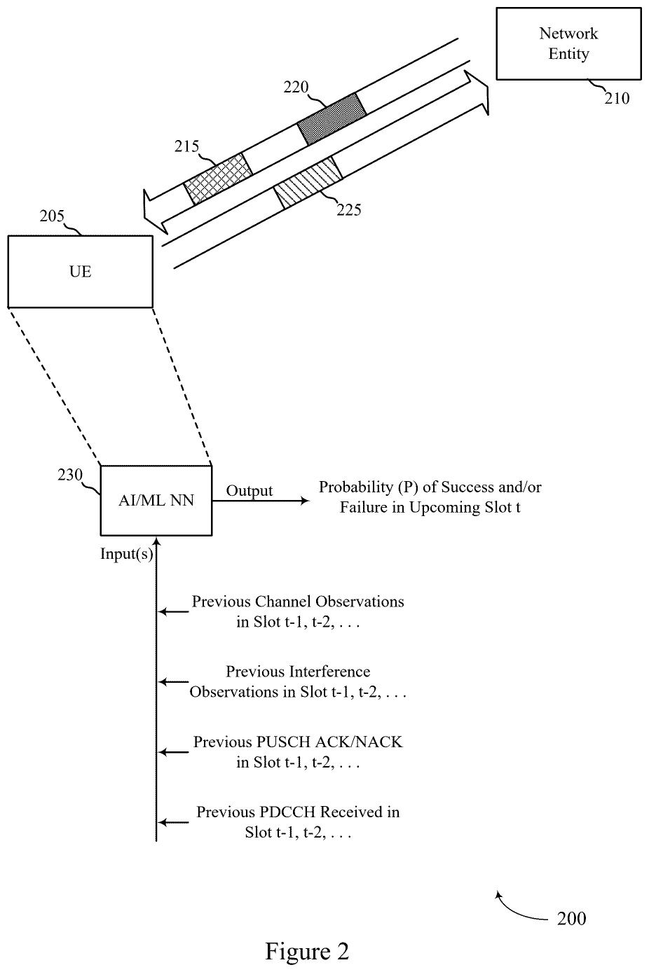

FIG. 2 shows an example of a signaling diagram 200 that supports UE autonomous uplink transmission based on AI/ML modeling. Aspects of the signaling diagram 200 may be implemented by aspects of and/or may implement aspects of the wireless communication system 100. Aspects of the signaling diagram 200 may be implemented at and/or implemented by a UE 205 and a network entity 210, which may be examples of the corresponding devices described herein. In some aspects, the UE 205 may include, support, or otherwise be associated with a learning model 230, which may be an example of an AI-based learning model, a ML-based learning model, and/or a NN-based learning model.

Wireless networks may configure UE with two types of semi-persistent uplink resources (e.g., CG-PUSCH resources according to a corresponding CG-PUSCH configuration). The Type 1 CG-PUSCH configuration may include a set of uplink CG-PUSCH transmission occasions according to a corresponding set of transmission parameters (e.g., modulation and coding scheme (MCS), quantity of MIMO layers, precoder, coding rate, and the like). The transmission parameters are the same for each CG-PUSCH transmission occasion scheduled or otherwise identified in the CG-PUSCH configuration. In the Type 1 CG-PUSCH configuration, the CG-PUSCH resources are active and available for autonomous use by the UE as soon as they are configured. The second type is a Type 2 CG-PUSCH configuration. This type is similar to the Type 1 CG-PUSCH configuration but the resources are first configured (e.g., semi-statically via RRC signaling) and then must be activated by the network (e.g., via DCI or MAC-CE signaling) before the UE can use these resources.

In some cases, the network may configure the UE with multiple CG-PUSCH configurations. In this case, each CG-PUSCH configuration will have a unique set of transmission parameters that are the same for each corresponding CG-PUSCH transmission occasion. That is, a first set of transmission parameters of a first CG-PUSCH configuration are the same for each CG-PUSCH transmission occasion scheduled by the first CG-PUSCH configuration. Similarly, a second set of transmission parameters of a second CG-PUSCH configuration are the same for each CG-PUSCH transmission occasion scheduled by the second CG-PUSCH configuration. As one example, the first set of transmission parameters may include a 16QAM modulation to be used during the first set of CG-PUSCH transmission occasions where the second set of transmission parameters may include a QPSK modulation to be used during the second set of CG-PUSCH transmission occasions.

Thus, the UE may generally monitor one or more buffers to identify when uplink information is available to be communicated to the network. If available, the UE may use the next upcoming CG-PUSCH transmission occasion to perform an uplink transmission (e.g., an autonomous PUSCH transmission) of the uplink information to the network. However, in some cases the channel conditions, mobility of the UE, and/or other factors may have changed since the CG-PUSCH configuration(s) had been configured for the UE. This may disrupt the uplink transmissions such that the network is unable to successfully receive and decode the uplink information. Such wireless networks may not provide a mechanism for the UE to select an optimal CG-PUSCH transmission occasion to perform the uplink transmission to the network.

Accordingly, aspects of the techniques described herein provide for adoption, implementation, and/or otherwise support for a learning model 230 at, by, and/or in cooperation with the UE 205 to improve autonomous PUSCH transmissions to the network (e.g., to the network entity 210). Broadly, before a CG-PUSCH transmission occasion, the UE 205 may use a NN or any other learning model to predict whether the autonomous PUSCH transmission will be successful or will fail. That is, the NN may predict the probability (P) of the PUSCH transmission to either succeed (P(success)) or to fail (P(fail)). If the probability of success fails to satisfy a network-configured threshold level (e.g., P<threshold), the UE 205 may defer the PUSCH transmission (e.g., an autonomous PUSCH transmission of uplink information during a CG-PUSCH transmission occasion) to a later CG-PUSCH transmission occasion. If the probability satisfies the network-configured threshold level (e.g., P≥threshold), the UE 205 may perform the uplink transmission in the next CG-PUSCH transmission occasion.

As discussed, the network may configure or otherwise indicate to the UE 205 the threshold level to be applied by the learning model 230 when performing autonomous PUSCH transmissions during CG-PUSCH transmission occasions. For example, at 215 the network entity 210 may transmit or otherwise output (and the UE 205 may receive or otherwise obtain) information that indicates or otherwise identifies the threshold level that corresponds to the probability of success (e.g., P(success) and/or P(fail)) for an autonomous PUSCH transmission by the UE 205. The indication of the threshold level may be provided to the UE via various signaling means (e.g., upper-layer signaling, RRC signaling, MAC-CE signaling, and/or DCI signaling). At 220, the network entity 210 may transmit or otherwise output (and the UE 205 may receive or otherwise obtain) a configuration signal that identifies one or more CG-PUSCH configurations. As discussed, each CG-PUSCH configuration may schedule, identify, or otherwise allocate a set of CG-PUSCH transmission occasions available for performing autonomous PUSCH transmissions by the UE 205.

Accordingly, at 225 the UE 205 may transmit or otherwise output (and the network entity 210 may receive or otherwise obtain) at least one autonomous PUSCH transmission during either a first CG-PUSCH transmission occasion or during a second CG-PUSCH transmission occasion. For example, the UE 205 may use the probability of success or failure and the network-configured threshold level to identify or otherwise determine whether to perform the autonomous PUCH transmission during the first CG-PUSCH transmission occasion or defer to the second CG-PUSCH transmission occasion. If the probability of success (P(success)) satisfies the threshold level, the UE 205 may perform the autonomous PUSCH transmission during the first CG-PUSCH transmission occasion. If the probability of success (P(success)) fails to satisfy the threshold level, the UE 205 may defer performing the autonomous PUSCH transmission until the second CG-PUSCH transmission occasion.

As discussed, in some aspects the decision whether to perform the autonomous PUSCH transmission during the first CG-PUSCH transmission occasion or defer to the second CG-PUSCH transmission occasion may be based on a learning model adopted or otherwise implemented by the UE 205. For example, the UE 205 may apply a learning model 230 to determine the probability of success and/or failure associated with the first CG-PUSCH transmission occasion. If the output of the learning model 230 (e.g., the probability of success or failure) satisfies the threshold level, the UE 205 may perform the autonomous PUSCH transmission during the first CG-PUSCH transmission occasion. If the output of the learning model 230 fails to satisfy the threshold level, the UE 205 may defer the autonomous PUSCH transmission until the second CG-PUSCH transmission occasion (which occurs later in the time domain relative to the first CG-PUSCH transmission occasion).

Broadly, various types of learning models may be applied as the learning model 230. That is, the learning model 230 may correspond to a NN learning model, a convolution NN (CNN) learning model, a recurrent NN (RNN), and/or an AI learning model. The learning model 230 may receive, obtain, or otherwise be associated with various inputs. The input(s) to the learning model 230 may include, but are not limited to, previous channel performance metrics, previous interference metrics, a success rate of prior PUSCH transmission(s), a success rate of prior PDxCH transmission(s) (e.g., PDCCH and/or PDSCH), and the like, during a set of slots occurring prior to a slot containing the first CG-PUSCH transmission occasion.

As shown, the inputs to the learning model 230 may include the previous channel observations (e.g., channel performance metrics) identified by the UE 205 during the set of slots (e.g., slot t−1, slot t−2, . . . ) prior to the slot containing the first CG-PUSCH transmission occasion (e.g., slot t). The inputs to the learning model 230 may include the previous interference observations (e.g., interference metrics) identified by the UE 205 during the set of slots. The inputs to the learning model 230 may include the success rate of the previous PUSCH transmissions (e.g., based on ACK/NACK feedback received for the previous PUSCH transmissions). The inputs to the learning model 230 may include the success rate of the previous PDxCH transmissions received by the UE 205 during the set of slots. The learning model 230 may analyze one or more of the inputs (e.g., in any combination) to output the probability (P) of whether the first CG-PUSCH transmission occasion occurring in slot t has a probability of success that satisfies the threshold level or fails to satisfy the threshold level.

In some aspects, the UE 205 may provide for channel performance/interference predictions and network receiver approximation functions. This may provide for a prediction of the uplink channel performance and interference (e.g., during the slot t). The UE 205 may know whether the previous PUSCH transmission(s) failed or succeeded (e.g., based on a new data indicator (NDI) and/or based on ACK/NACK feedback). Accordingly, the UE 205 may approximate the behavior of the receiver (e.g., the network entity 210, in this example), such as whether a PUSCH transmission using QPSK modulation can be decoded by the network entity 210 at a signal-to-noise ratio (SNR) of x dB, whether a PUSCH transmission using 16QAM modulation can be decoded by the network entity 210 at a SNR of y dB, and the like.

However, the operations of the learning model 230 may be simpler than the channel predictor and receiver approximation functions. The learning model 230 may not actually need to predict the channel performance as well as the receiver details. Instead, the UE 205 (e.g., the learning model 230) may predict the probability of success or failure of the future PUSCH transmissions based on the previous channel performance and interference observations or measurements by the UE 205. As discussed, the threshold level may be defined with respect to the probability of success and/or with respect to the probability of failure.

In some aspects, the learning model 230 may adopt a supervised learning problem approach to determine the probability of success or failure. The inputs may be the past channel and interference observations in slots t−1, t−2, . . . , t−K, where K is based on the memory or buffer length of the UE 205. The learning model 230 may predict the output as the probability of PUSCH decoding failure or success in an upcoming slot t. For example, the training data may include, for slot t−K, the channel measurement (hₜ₋ₓ), the interference measurement (i_{t-K}), and optionally the PUSCH transmission failure or success rate (l_{t-K}). For the slot t−3, the training data may include the channel measurement (hₜ₋₃), the interference measurement (iₜ₋₃), and optionally the PUSCH transmission failure or success rate (lₜ₋₃). For the slot t−2, the training data may include the channel measurement (hₜ₋₂), the interference measurement (iₜ₋₂), and optionally the PUSCH transmission failure or success rate (lₜ₋₂). Lastly, for the slot t−1, the training data may include the channel measurement (hₜ₋₁), the interference measurement (iₜ₋₁), and optionally the PUSCH transmission failure or success rate (lₜ₋₁).

The learning model 230 may use this training data to predict the probability of success and/or failure of the UE 205 performing the autonomous PUSCH transmission during the first CG-PUSCH transmission occasion (e.g., during slot t). If the probability of success satisfies the threshold level, the UE 205 may use the first CG-PUSCH transmission occasion to perform the autonomous PUSCH transmission (e.g., according to the transmission parameters defined by the corresponding CG-PUSCH configuration). If the probability of success fails to satisfy the threshold level, the UE 205 may defer the autonomous PUSCH transmission to a later CG-PUSCH transmission occasion (e.g., the second CG-PUSCH transmission occasion during slot t+x, where x is a positive number).

In some aspects, the NN (e.g., the learning model 230) may be developed and trained at the UE 205. In this case, the model details of the NN may be transparent to the network.

In some aspects, the network may help the UE 205 to develop and train the NN by the collection and sharing of various training data to the UE 205 and/or to a UE side server (e.g., a server operating to manage, control, or otherwise be associated with aspects of the learning model 230 associated with the UE 205). For example, the network entity 210 may transmit or otherwise output (and the UE 205 may receive or otherwise obtain) one or more inputs to be applied to the learning model 230. As discussed, the learning model 230 is applied to determine whether to perform the autonomous PUSCH transmission during the first CG-PUSCH transmission occasion or defer to the second CG-PUSCH transmission occasion. In some aspects, the one or more inputs provided by the network may be based on a channel whitening procedure and/or based on a channel impulse response (CIR).

Accordingly, in some aspects the network may help the UE 205 train the NN by the collection of training data and sharing the training data set to the UE 205 and/or to a UE side server. When the network collects such training data, this may include adoption of a system to collect data such as the network collecting and sharing the channel estimation(s) associated with PUSCH transmissions in past slots and/or the network collecting and sharing the interference estimation(s) associated with PUSCH transmissions in the past slots. The output, based on usage of such training data, may include an output, label, and/or a ground-truth indication of whether the PUSCH decoding was a failure or success in the past slots.

Thus, in some cases (e.g., without network assistance), the UE 205 may implicitly figure out whether the past PUSCH transmission(s) failed or succeed based on the NDI associated with later PUSCH transmissions with the same HARQ identifier. The NDI may reflect a past PUSCH transmission success or failure. That is, the NDI of a PUSCH transmission indicating new data being transmitted may indicate or otherwise mean that the past PUSCH transmission having the same HARQ identifier was successful, while the NDI indicating a retransmission may indicate or otherwise mean the past PUSCH transmission was a failure. In some aspects, the NDI may not perfectly indicate or otherwise reflect the past PDSCH transmission decoding outcome (e.g., as the network may give up scheduling a retransmission for a failed PUSCH transmission). In some aspects, for each past PUSCH transmission, the network may send ACK/NACK feedback to tell the UE 205 whether the past PUSCH transmission was successfully decoded or failed to be decoded.

In some aspects, a training data point may include {estimated channel (h), estimated interference (i), slot index (t), PUSCH succeed/failure, etc.}. The network may collect such training data points in or for multiple slots then send this information (e.g., inputs) to the UE 205 together (e.g., in one pack of training data). Accordingly, the learning model 230 may essentially predict the network behavior which may be common for some or all UEs. The network may aggregate the training data points collected from PUSCH transmissions sent by multiple UEs in the past slots, which may reduce the training data set collection timeline. In some aspects, the framework to share the training data set from the network to the UE 205 for CSI compression (e.g., a two-sided model) can be used.

In some aspects, if the network sends raw data (e.g., estimated channel (h), estimated interference (i), slot index (t)) to the UE 205, the overhead might be large. Accordingly, aspects of the described techniques may be used to reduce the overhead associated with the network sharing the training data set (e.g., the inputs) with the UE 205. One approach to reduce the overhead may include the network sending whitened channel information to the UE 205. The whitened channel information may be based on \tilde{H}=R^{-1/2} H, where R is the covariance matrix of the interference plus noise estimation.

Another approach to reduce the overhead may be based on, even with the channel whitening, the overhead might still be large (e.g., such as if the network sends the frequency domain channel [symbol] with a wideband channel). Accordingly, instead of the network sending the frequency domain channel [symbol] , the network may send information related to the CIR of [symbol] in the time domain, which may be represented by {channel tap locations, amplitude and phase of each tap}. At the UE side, the UE 205 may not need to convert the time domain channel information into the frequency domain. Instead, the UE 205 may train the NN directly with the time domain channel information.

Another approach to reduce the overhead reduction method may be based on an assumption of channel reciprocity (e.g., for TDD-based operations). The network may send {estimated interference, slot index} to the UE 205, in this example. For example, the estimated interference may be the interference covariance matrix at slot t-k. One variation of this approach is based on only training the NN based on TDD-based reciprocal channel measurement based on CSI-RS.

In some aspects, to mitigate the overhead the network may use the downlink channel to train the NN by assuming channel reciprocity in the TDD-based operations. As discussed, one example of simplifying the NN model is, rather than use the past channel performance metrics and the past channel interference metrics, to use the past PUSCH ACK/NACK feedback and the past PDxCH receptions (e.g., either or both of PDCCH and PDSCH receptions) as inputs to the learning model 230.

Thus, one example may include assuming a memory length of K=3 (e.g., using the channel performance and interference metrics for the previous three slots) to predict whether the upcoming slot (e.g., t) PUSCH transmission will succeed or fail. From the training data set, this may include forming a sequence of training data points where each training data point may include the {channel measurements (h) of previous K slots, interference measurements (i) of previous K slots, and a label at the current slot (t)}.

In some cases, after the models are trained and tested, the UE 205 may send a signal to the network to register the models and tell network the models are ready to use. For example, the UE 205 may transmit or otherwise output (and the network entity 210 may receive or otherwise obtain) a message that registers the one or more learning models of the UE 205 with the network entity 210. Thus, in some cases multiple models may be trained. For example, the UE 205 may train two models where one model is a more optimistic model to predict the PUSCH decoding success and the other model is a more pessimistic model to predict the PUSCH decoding failure.

In some cases, the network may send a signal to the UE 205 that enables or disables use of the learning models. For example, the network entity 210 may transmit or otherwise output (and the UE 205 may receive or otherwise obtain) a message that enables (or disables) support for the learning model 230 by the UE 205. Again, the learning model 230 may be applied to determine whether to perform the autonomous PUSCH transmission during the first CG-PUSCH transmission occasion or defer to the second CG-PUSCH transmission occasion (e.g., based on the model output and the threshold value). Thus, the network may send signaling to enable the UE 205 to use the NN and, in some cases, which model is to be used (e.g., based on a model identifier indication) in the situation where multiple models are available.

In some cases, the network may monitor the model performance and indicate to the UE 205 to switch to a different model or to stop using the NN. For example, the network entity 210 may transmit or otherwise output (and the UE 205 may receive or otherwise obtain) a message that indicates for the UE 205 to switch from a first learning model to a second learning model. The first and second learning models may include separate models that have been trained by the learning model 230. For example, the network may observe the CG-PUSCH transmission occurrences and their associated decoding success rate. If the network identifies or otherwise determines that the CG-PUSCH success rate is higher than an expected operational point (e.g., 90%), this may indicate the model is too conservative or pessimistic. If the network observed success rate is lower than the operational point, this may indicate that the model is too aggressive or optimistic. The network may indicate to the UE 205 to switch the models accordingly.

This aspect may be based on a trade-off between PUSCH transmission delays and success rates. If the network wants to reduce the delays, the network can indicate for the UE 205 to use a more optimistic model. If the network wants to boost the success rate, the network may indicate for the UE 205 to use a more pessimistic model.

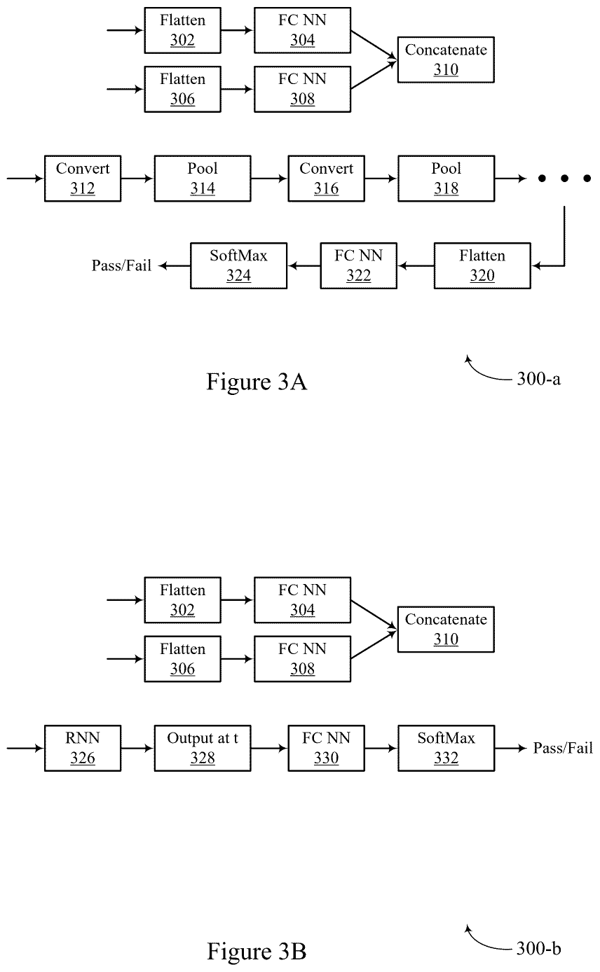

FIGS. 3A and 3B show examples of an AI/ML NN 300 that supports UE autonomous uplink transmission based on AI/ML modeling. Aspects of the AI/ML NN 300 may implement and/or be implemented by aspects of the wireless communication system 100 and/or aspects of the signaling diagram 200. Aspects of the AI/ML NN 300 may be implemented at and/or implemented by a UE and/or a network entity, which may be examples of the corresponding devices described herein. The AI/ML NN 300-a of FIG. 3A illustrates an example where the learning model adopted by the UE is a CNN and the AI/ML NN 300-b of FIG. 3B illustrates an example where the learning model adopted by the UE is an RNN.

As discussed above, aspects of the techniques described herein may include the UE adopting a learning model to determine whether to perform an autonomous PUSCH transmission during a first CG-PUSCH transmission occasion or to defer the autonomous PUSCH transmission until a second CG-PUSCH transmission occasion (e.g., that occurs later in time relative to the first CG-PUSCH transmission occasion). For example, the UE may receive or otherwise obtain (and the network entity may transmit or otherwise output) information that identifies the threshold level or value that corresponds to a probability of success for the autonomous PUSCH transmission by the UE. The UE may receive or otherwise obtain (and the network entity may transmit or otherwise output) a configuration signal that identifies one or more CG-PUSCH configurations. Each CG-PUSCH configuration may include a set of CG-PUSCH transmission occasions available for performing autonomous PUSCH transmissions by the UE. The transmission parameters for each CG-PUSCH transmission occasion may be the same for a given CG-PUSCH configuration but may differ between different CG-PUSCH configurations.

The UE may transmit or otherwise output (and the network entity may receive or otherwise obtain) at least one autonomous PUSCH transmission during a first CG-PUSCH transmission occasion or during a second CG-PUSCH transmission occasion based on the threshold level and the probability of success associated with the first CG-PUSCH transmission occasion. For example, the UE may apply a learning model to determine the probability of success associated with the first CG-PUSCH transmission occasion. If the output of the learning model indicates the probability of success satisfies the threshold level, the UE may perform the autonomous PUSCH transmission during the first CG-PUSCH transmission occasion. If the output of the learning model indicates the probability of success fails to satisfy the threshold level, the UE may defer the autonomous PUSCH transmission to the second CG-PUSCH transmission occasion. As discussed, different types of learning models may be applied by the UE to determine the probability of success for the autonomous PUSCH transmission.

Turning first to the AI/ML NN 300-a of FIG. 3A, in this example the learning model may be a CNN. A CNN generally uses a series of convolution layers (e.g., kernels) that apply filters to the training data to learn and extract various features or information. This may be based on the CNN performing feature processing for each k=1, . . . , K. As one example, the input related to the channel performance

$$( e . g . , {h}_{t - k}^{M \times N} )$$

may be applied to a flatten function 302 while the input related to the interference metric

$$( e . g . , {i}_{t}^{M \times N} )$$

may be applied to a flatten function 306. Each flatten function (e.g., both the flatten function 302 and the flatten function 306) may operate as a flatten layer and may involve a step that converts the multi-dimensional information into a one-dimensional vector. The flattened vector may be applied as inputs to fully connected (FC) layers, which may be associated with classification or other tasks. For example, the output of the flatten function 302 may be applied as an input to the FC NN 304 while the output of the flatten function 306 may be applied as an input to the FC NN 308. The FC NN may generally correspond to a layer where every neuron of the NN is fully connected to every neuron in the previous layer. That is, all possible connections between two layers may be present. Thus, the output of the FC NN 304 may correspond to a feature vector with a length D1 and the output of the FC NN 308 may correspond to a feature vector with a length D1. The outputs of each FC NN may be provided as inputs to the concatenate function 310 for concatenation. That is, the output of the concatenate function 310 may be a feature vector (F) with a length of D=D1+D2.

After this initial stage, a one-dimensional CNN network may be used to further process the concatenated feature across K slots. For example, an input to the convert function 312 may correspond to the feature vector (F) according to F^{K×D}. The convert function 312 may generally convert the feature vector (F) in the k (e.g., time) dimension. This may include converting the time-series signal into a format that can be effectively processed by the NN. In some cases, this may include using convolution operations along the time axis to extract temporal features from the data. The output of the convert function 312 may be applied as an input to the pool function 314, which may generally be used to reduce the spatial dimensions (e.g., width and height) of the input feature maps while retaining the most important information. This may be based on sliding a two-dimensional filter over each channel of a feature map and summarizing the features within the region covered by the filter.

This process may be repeated one or more times, such as where the output of the pool function 314 being applied as an input to the convert function 316 and the output of the convert function 316 being applied as an input to the pool function 318. Upon completion of this process, the output of the process may be applied as an input to a flatten function 320 with the output of the flatten function 320 being applied as an input to the FC NN 322. The output of the FC NN 322 may be applied as an input to the soft max function 324, which may adjust the outputs of the CNN so that they sum to one. That is, the soft max function 324 may provide a model output value that is scaled so as to be thought of as a probability that a certain category or outcome was predicted by the CNN. Thus, the output of the soft max function 324 may correspond to the probability of success (e.g., P(success)) and/or the probability of failure (e.g., P(fail)) associated with the first CG-PUSCH transmission occasion.

Turning next to the AI/ML NN 300-b of FIG. 3B, in this example the learning model applied by the UE may correspond to an RNN. The RNN may begin with the feature processing for each k=1, . . . , K (e.g., similar to the CNN model discussion above). For example, the previous channel performance metrics (h), the previous channel interference metrics (i) may be applied to the flatten function 302 and the FC NN 304 and to the flatten function 306 and the FC NN 308, respectively. Again, the output of the FC NN 304 may correspond to a feature vector with a length D1 and the output of the FC NN 308 may correspond to a feature vector with a length D2. Both feature vectors may be applied to the concatenate function 310 which may output the feature vector F with length D=D1+D2.

The output of the concatenate function 310 may be applied to a RNN 326 for processing. That is, the RNN 326 may correspond to a deep learning model designed to process and predict sequential data, such as text or time series data. In some aspects, the RNN 326 may correspond to a long short-term memory (LSTM) RNN or a gated recurrent unit (GRU) RNN. The output of the RNN 326 may be provided as an input to the output function 328 that takes the output at t (e.g., in the time domain). This output may be applied as an input to the FC NN 330 which provides its output to the soft max function 332 as an input. Again, the output of the soft max function 332 may correspond to the probability of success or failure associated with the first CG-PUSCH transmission occasion.

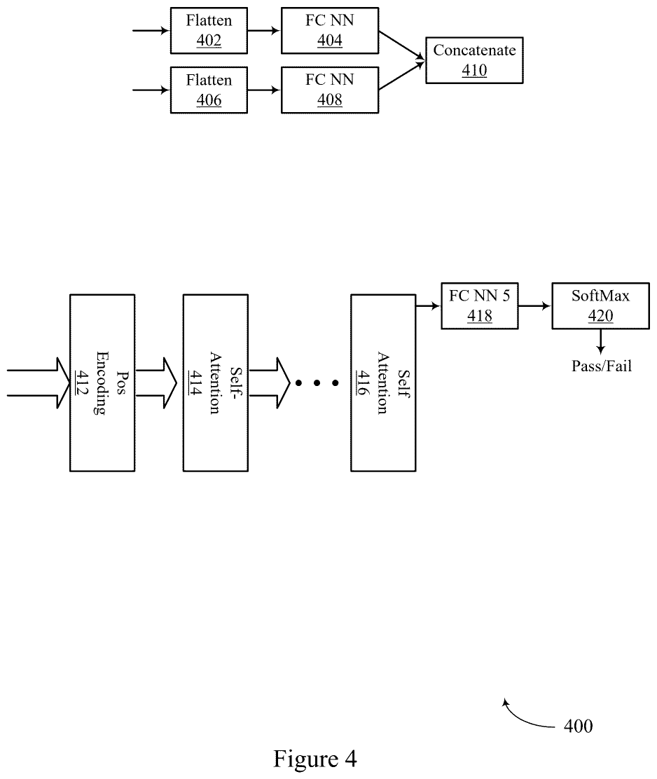

FIG. 4 shows an example of an AI/ML NN 400 that supports UE autonomous uplink transmission based on AI/ML modeling. Aspects of the AI/ML NN 400 may implement and/or be implemented by aspects of the wireless communication system 100 and/or aspects of the signaling diagram 200. Aspects of the AI/ML NN 400 may be implemented at and/or implemented by a UE and/or a network entity, which may be examples of the corresponding devices described herein.

As discussed above, aspects of the techniques described herein may include the UE adopting a learning model to determine whether to perform an autonomous PUSCH transmission during a first CG-PUSCH transmission occasion or to defer the autonomous PUSCH transmission until a second CG-PUSCH transmission occasion (e.g., that occurs later in time relative to the first CG-PUSCH transmission occasion). For example, the UE may receive or otherwise obtain (and the network entity may transmit or otherwise output) information that identifies the threshold level or value that corresponds to a probability of success for the autonomous PUSCH transmission by the UE. The UE may receive or otherwise obtain (and the network entity may transmit or otherwise output) a configuration signal that identifies one or more CG-PUSCH configurations. Each CG-PUSCH configuration may include a set of CG-PUSCH transmission occasions available for performing autonomous PUSCH transmissions by the UE. The transmission parameters for each CG-PUSCH transmission occasion may be the same for a given CG-PUSCH configuration but may differ between different CG-PUSCH configurations.

The UE may transmit or otherwise output (and the network entity may receive or otherwise obtain) at least one autonomous PUSCH transmission during a first CG-PUSCH transmission occasion or during a second CG-PUSCH transmission occasion based on the threshold level and the probability of success associated with the first CG-PUSCH transmission occasion. For example, the UE may apply a learning model to determine the probability of success associated with the first CG-PUSCH transmission occasion. If the output of the learning model indicates the probability of success satisfies the threshold level, the UE may perform the autonomous PUSCH transmission during the first CG-PUSCH transmission occasion. If the output of the learning model indicates the probability of success fails to satisfy the threshold level, the UE may defer the autonomous PUSCH transmission to the second CG-PUSCH transmission occasion. As discussed, different types of learning models may be applied by the UE to determine the probability of success for the autonomous PUSCH transmission.

The AI/ML NN 400 illustrates an example where the learning model applied by the UE may correspond to a transformer network structure. The NN may begin with the feature processing for each k=1, . . . , K (e.g., similar to the CNN/RNN models discussion above). For example, the previous channel performance metrics (h) and the previous channel interference metrics (i) may be applied to the flatten function 402 and the FC NN 404 and to the flatten function 406 and the FC NN 408, respectively. Again, the output of the FC NN 404 may correspond to a feature vector with length D1 and the output of the FC NN 408 may correspond to a feature vector with length D2. Both feature vectors may be applied to the concatenate function 410 which may output the feature vector F with length D=D1+D2.

The output of the concatenate function 410 may be applied to a transformer for processing across K slots. For example, the output of the concatenate function 410 may be applied to a position encoding function 412 for position encoding. That is, the inputs to the position encoding function 412 may correspond to pad leamble parameters with a dimension of Dx1. The pad leamble parameters may be based on the padding of input data to a fixed size before application of a linear transformation (such as when using variable-length sequences or inputs). Additional inputs to the position encoding function 412 may correspond to the F^{K×D} for

$${F}_{1}^{K \times D} , {F}_{2}^{K \times D} , … , {F}_{K}^{K \times D} .$$

The output of the position encoding function 412 may be applied as an input to one or more instances of the self-attention function 414, the self-attention function 416, etc. (e.g., the transformer encoder function).

The output of the last stage of the transformer encoder function (e.g., the self-attention function 416, in this example) may include the classification (CLS) token that is used to generate a sequence-level representation for the classification of tasks. That is, the CLS output may be a learned representation that aggregates information from all other tokens in the input sequence. Thus, the output of the self-attention function 416, in this example, may be provided as inputs to the FC NN 418 for processing with the output of the FC NN 418 being applied as an input to the soft max function 420. Again, the output of the soft max function 420 may include the indication of the probability of success and/or failure associated with the first CG-PUSCH transmission occasion.

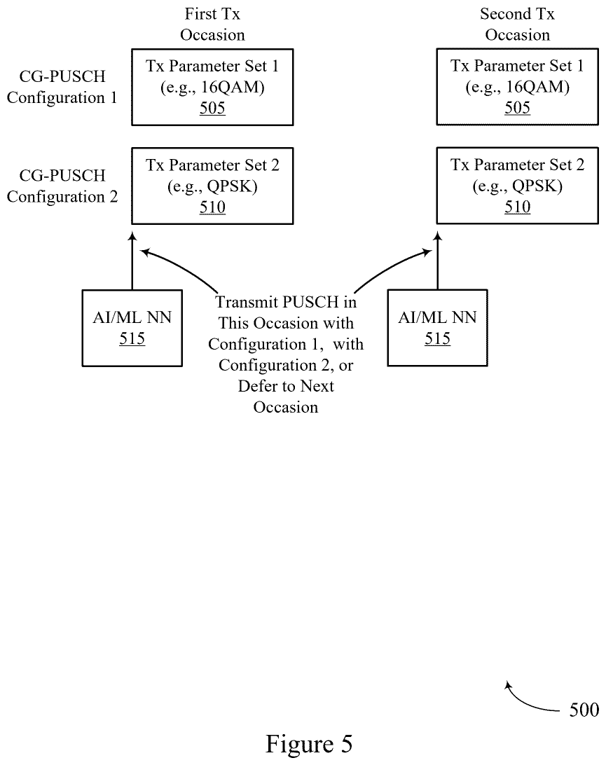

FIG. 5 shows an example of a diagram 500 that supports UE autonomous uplink transmission based on AI/ML modeling. Aspects of the diagram 500 may implement and/or be implemented by aspects of the wireless communication system 100, aspects of the signaling diagram 200, and/or aspects of the AI/ML NN 300 and/or the AI/ML NN 400. Aspects of the diagram 500 may be implemented at and/or implemented by a UE and/or a network entity, which may be examples of the corresponding devices described herein.

As discussed above, aspects of the techniques described herein may include the UE adopting a learning model to determine whether to perform an autonomous PUSCH transmission during a first CG-PUSCH transmission occasion or to defer the autonomous PUSCH transmission until a second CG-PUSCH transmission occasion (e.g., that occurs later in time relative to the first CG-PUSCH transmission occasion). For example, the UE may receive or otherwise obtain (and the network entity may transmit or otherwise output) information that identifies the threshold level or value that corresponds to a probability of success for the autonomous PUSCH transmission by the UE. The UE may receive or otherwise obtain (and the network entity may transmit or otherwise output) a configuration signal that identifies one or more CG-PUSCH configurations. Each CG-PUSCH configuration may include a set of CG-PUSCH transmission occasions available for performing autonomous PUSCH transmissions by the UE. The transmission parameters for each CG-PUSCH transmission occasion may be the same for a given CG-PUSCH configuration but may differ between different CG-PUSCH configurations.

The UE may transmit or otherwise output (and the network entity may receive or otherwise obtain) at least one autonomous PUSCH transmission during a first CG-PUSCH transmission occasion or during a second CG-PUSCH transmission occasion based on the threshold level and the probability of success associated with the first CG-PUSCH transmission occasion. For example, the UE may apply a learning model to determine the probability of success associated with the first CG-PUSCH transmission occasion. If the output of the learning model indicates the probability of success satisfies the threshold level, the UE may perform the autonomous PUSCH transmission during the first CG-PUSCH transmission occasion. If the output of the learning model indicates the probability of success fails to satisfy the threshold level, the UE may defer the autonomous PUSCH transmission to the second CG-PUSCH transmission occasion. As discussed, different types of learning models may be applied by the UE to determine the probability of success for the autonomous PUSCH transmission.

Aspects of the diagram 500 illustrates an example where the described techniques are extended to multiple CG-PUSCH configurations per UE. For example, the one or more CG-PUSCH configurations configured for the UE may include a first CG-PUSCH configuration and a second CG-PUSCH configuration. Each CG-PUSCH configuration may be associated with a corresponding set of CG-PUSCH transmission occasions. In some cases, the first CG-PUSCH transmission occasion may be associated with the first CG-PUSCH configuration while the second CG-PUSCH transmission occasion may be associated with the second CG-PUSCH configuration. The first set of CG-PUSCH transmission occasions associated with the first CG-PUSCH configuration may be associated with a first set of transmission parameters while the second set of CG-PUSCH transmission occasions associated with the second CG-PUSCH configuration may be associated with a second set of transmission parameters. Examples of the transmission parameters include, but are not limited to, an MCS, a number of MIMO layers, a precoder, and the like. Generally, the diagram 500 illustrates an example where the UE may apply the NN to decide not only transmitting or deferring the autonomous PUSCH transmission but also deciding the best CG-PUSCH configuration to be used for the autonomous PUSCH transmission.

For example, the first CG-PUSCH configuration may be associated with a first transmission parameter set 505 while the second CG-PUSCH configuration may be associated with a second transmission parameter set 510. As the first CG-PUSCH configuration is associated with a set of CG-PUSCH transmission occasions, the first transmission parameter set 505 of the first CG-PUSCH configuration may be available for use during a first CG-PUSCH transmission (Tx) occasion and during a second CG-PUSCH transmission occasion. Similarly, as the second CG-PUSCH configuration is associated with a set of CG-PUSCH transmission occasions, the second transmission parameter set 510 of the second CG-PUSCH configuration may also be available for use during the first CG-PUSCH transmission occasion and during the second CG-PUSCH transmission occasion.

Thus, before each CG-PUSCH transmission occasion the UE may apply a learning model 515 to determine whether to perform an autonomous PUSCH transmission during this upcoming CG-PUSCH transmission occasion or to defer the autonomous PUSCH transmission to the second CG-PUSCH transmission occasion. Moreover, in this example the learning model 515 may also determine whether to use the first CG-PUSCH configuration with the first transmission parameter set 505 or to use the second CG-PUSCH configuration with the second transmission parameter set 510. That is, the learning model (e.g., the learning model 515, in this example) may provide as an output a probability of success or failure for performing the autonomous PUSCH transmission during the first CG-PUSCH transmission occasion using both or either of the first CG-PUSCH configuration or the second CG-PUSCH configuration.

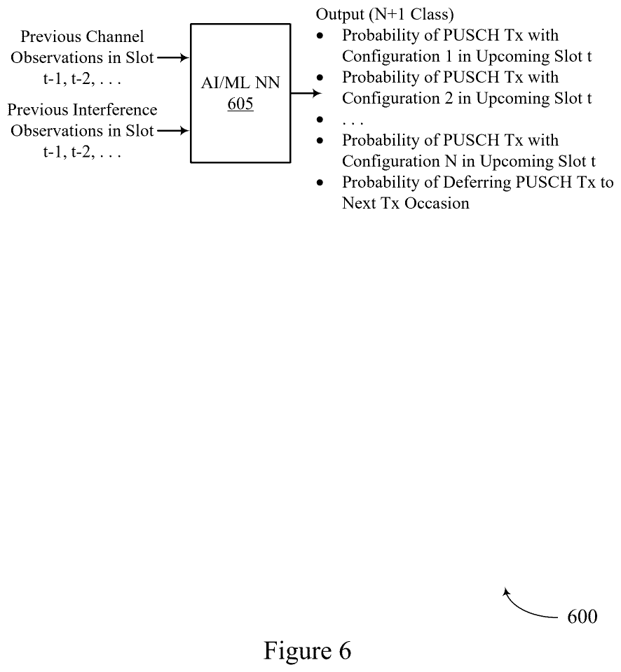

FIG. 6 shows an example of a diagram 600 that supports UE autonomous uplink transmission based on AI/ML modeling. Aspects of the diagram 600 may implement and/or be implemented by aspects of the wireless communication system 100, aspects of the signaling diagram 200, aspects of the AI/ML NN 300 and/or the AI/ML NN 400, and/or aspects of the diagram 500. Aspects of the diagram 600 may be implemented at and/or implemented by a UE and/or a network entity, which may be examples of the corresponding devices described herein.

As discussed above, aspects of the techniques described herein may include the UE adopting a learning model to determine whether to perform an autonomous PUSCH transmission during a first CG-PUSCH transmission occasion or to defer the autonomous PUSCH transmission until a second CG-PUSCH transmission occasion (e.g., that occurs later in time relative to the first CG-PUSCH transmission occasion). For example, the UE may receive or otherwise obtain (and the network entity may transmit or otherwise output) information that identifies the threshold level or value that corresponds to a probability of success for the autonomous PUSCH transmission by the UE. The UE may receive or otherwise obtain (and the network entity may transmit or otherwise output) a configuration signal that identifies one or more CG-PUSCH configurations. Each CG-PUSCH configuration may include a set of CG-PUSCH transmission occasions available for performing autonomous PUSCH transmissions by the UE. The transmission parameters for each CG-PUSCH transmission occasion may be the same for a given CG-PUSCH configuration but may differ between different CG-PUSCH configurations.

The UE may transmit or otherwise output (and the network entity may receive or otherwise obtain) at least one autonomous PUSCH transmission during a first CG-PUSCH transmission occasion or during a second CG-PUSCH transmission occasion based on the threshold level and the probability of success associated with the first CG-PUSCH transmission occasion. For example, the UE may apply a learning model to determine the probability of success associated with the first CG-PUSCH transmission occasion. If the output of the learning model indicates the probability of success satisfies the threshold level, the UE may perform the autonomous PUSCH transmission during the first CG-PUSCH transmission occasion. If the output of the learning model indicates the probability of success fails to satisfy the threshold level, the UE may defer the autonomous PUSCH transmission to the second CG-PUSCH transmission occasion. As discussed, different types of learning models may be applied by the UE to determine the probability of success for the autonomous PUSCH transmission.

Aspects of the diagram 600 illustrates an example where the described techniques are extended to multiple CG-PUSCH configurations per UE. For example, the one or more CG-PUSCH configurations configured for the UE may include a first CG-PUSCH configuration and a second CG-PUSCH configuration. Each CG-PUSCH configuration may be associated with a corresponding set of CG-PUSCH transmission occasions. In some cases, the first CG-PUSCH transmission occasion may be associated with the first CG-PUSCH configuration while the second CG-PUSCH transmission occasion may be associated with the second CG-PUSCH configuration. The first set of CG-PUSCH transmission occasions associated with the first CG-PUSCH configuration may be associated with a first set of transmission parameters while the second set of CG-PUSCH transmission occasions associated with the second CG-PUSCH configuration may be associated with a second set of transmission parameters. Examples of the transmission parameters include, but are not limited to, an MCS, a number of MIMO layers, a precoder, and the like.

Generally, the diagram 600 illustrates an example where the network has configured N CG-PUSCH configurations for the UE and the learning model 605 applied by the UE may correspond to a classifier NN with N+1 output classes. For example, the inputs to the learning model 605 may correspond to the previous channel observations in slots t−1, t−2, . . . , the previous channel interference observations in the slots t−1, t−2, . . . , etc. The learning model 605 may use the inputs to output the probability of success associated with the first CG-PUSCH transmission occasion.

For example, the output of the learning model 605 may correspond to N+1 output classes. As shown, the outputs of the learning model 605 may include a probability of success of an autonomous PUSCH transmission using the first CG-PUSCH configuration in an upcoming slot t, a probability of success for the autonomous PUSCH transmission using the second CG-PUSCH configuration in the upcoming slot t, and so forth, until a probability of the autonomous PUSCH transmission with the CG-PUSCH configuration N in the upcoming slot t, as well as the probability of deferring the autonomous PUSCH transmission to the next CG-PUSCH transmission occasion (e.g., the second CG-PUSCH transmission occasion).

Thus, this example may correspond to a supervised learning problem. The inputs to the learning model 605 may be the past channel and interference metrics observed or measured by the UE in slot t−1, t−2, . . . , t−K (where K is the memory length). The NN prediction outputs may be the probabilities of each of the N+1 actions that UE can take in the upcoming slot t. The first action is that the UE transmits the autonomous PUSCH transmission with the first CG-PUSCH configuration. The second action is that the UE transmits the autonomous PUSCH transmission with the second CG-PUSCH configuration. This may repeat for each available output action.

Thus, in this example the NN structure may be easily extended from a two class classification to an N+1 class classification. In some aspects, the vanilla loss function associated with training the NN may be the cross entropy between generated actions {P(Action 1), P(Action 2), . . . , P(action N+1)} based on the training data and the label or ground-truth (e.g., the decision of one action out of N choices). In this aspect, the

$$Loss = - {\sum }_{all training data} {\sum }_{n = 1}^{N + 1} {Q}_{n} log ( {P}_{n} ) ,$$

where Qn is the probability of action n given by the label or ground-truth (e.g., the probability output) and Pn is the predicted probabilities from the NN. In some cases, the cost function may be modified by considering the reward of taking a different action is different with the following spectrum efficiency: weighted

$$loss = - {\sum }_{all training data} {\sum }_{n = 1}^{N + 1} {SE}_{n} {Q}_{n} log ( {P}_{n} ) ,$$

where SEₙ is the spectrum efficiency of PUSCH transmission with action n. In some aspects related to the spectrum efficiency weighted loss, the definition of spectrum efficient (SE) with action N=1 (e.g., deferring PUSCH) may have a SE=0. Setting the SE to >0 may artificially include this in the loss function.

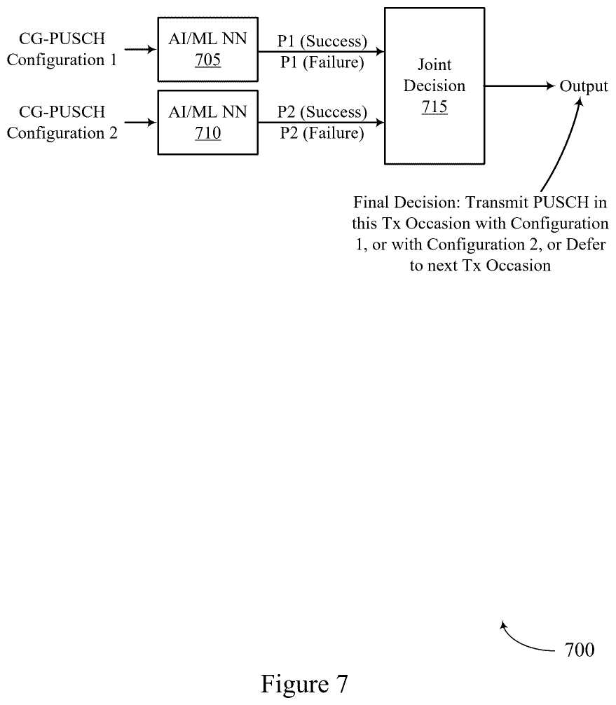

FIG. 7 shows an example of a diagram 700 that supports UE autonomous uplink transmission based on AI/ML modeling. Aspects of the diagram 700 may implement and/or be implemented by aspects of the wireless communication system 100, aspects of the signaling diagram 200, aspects of the AI/ML NN 300 and/or the AI/ML NN 400, and/or aspects of the diagram 500 and/or the diagram 600. Aspects of the diagram 700 may be implemented at and/or implemented by a UE and/or a network entity, which may be examples of the corresponding devices described herein.

As discussed above, aspects of the techniques described herein may include the UE adopting a learning model to determine whether to perform an autonomous PUSCH transmission during a first CG-PUSCH transmission occasion or to defer the autonomous PUSCH transmission until a second CG-PUSCH transmission occasion (e.g., that occurs later in time relative to the first CG-PUSCH transmission occasion). For example, the UE may receive or otherwise obtain (and the network entity may transmit or otherwise output) information that identifies the threshold level or value that corresponds to a probability of success for the autonomous PUSCH transmission by the UE. The UE may receive or otherwise obtain (and the network entity may transmit or otherwise output) a configuration signal that identifies one or more CG-PUSCH configurations. Each CG-PUSCH configuration may include a set of CG-PUSCH transmission occasions available for performing autonomous PUSCH transmissions by the UE. The transmission parameters for each CG-PUSCH transmission occasion may be the same for a given CG-PUSCH configuration but may differ between different CG-PUSCH configurations.

The UE may transmit or otherwise output (and the network entity may receive or otherwise obtain) at least one autonomous PUSCH transmission during a first CG-PUSCH transmission occasion or during a second CG-PUSCH transmission occasion based on the threshold level and the probability of success associated with the first CG-PUSCH transmission occasion. For example, the UE may apply a learning model to determine the probability of success associated with the first CG-PUSCH transmission occasion. If the output of the learning model indicates the probability of success satisfies the threshold level, the UE may perform the autonomous PUSCH transmission during the first CG-PUSCH transmission occasion. If the output of the learning model indicates the probability of success fails to satisfy the threshold level, the UE may defer the autonomous PUSCH transmission to the second CG-PUSCH transmission occasion. As discussed, different types of learning models may be applied by the UE to determine the probability of success for the autonomous PUSCH transmission.

Aspects of the diagram 700 illustrates an example where the described techniques are extended to multiple CG-PUSCH configurations per UE. For example, the one or more CG-PUSCH configurations configured for the UE may include a first CG-PUSCH configuration and a second CG-PUSCH configuration. Each CG-PUSCH configuration may be associated with a corresponding set of CG-PUSCH transmission occasions. In some cases, the first CG-PUSCH transmission occasion may be associated with the first CG-PUSCH configuration while the second CG-PUSCH transmission occasion may be associated with the second CG-PUSCH configuration. The first set of CG-PUSCH transmission occasions associated with the first CG-PUSCH configuration may be associated with a first set of transmission parameters while the second set of CG-PUSCH transmission occasions associated with the second CG-PUSCH configuration may be associated with a second set of transmission parameters. Examples of the transmission parameters include, but are not limited to, an MCS, a number of MIMO layers, a coding rate, a precoder, and the like.

Generally, the diagram 700 illustrates an example where the network has configured N CG-PUSCH configurations for the UE. However, in this example instead of designing a N+1 class classifier, the learning model may correspond to a two-class classifier used to predict the probability of success or failure for each CG-PUSCH configuration. This may include designing the criteria used to make the final decision based on the N 2-class classifier's output. One example criteria may be if the maximum spectrum efficiency R=maxₙ{SEₙ Pₙ(success)}>a threshold, the UE may transmit the autonomous PUSCH transmission with the CG-PUSCH configuration n to achieve the maximum spectrum efficiency. Otherwise, the UE may defer the transmission to a future slot (e.g., the second CG-PUSCH transmission occasion). In some cases, the threshold level may be updated by the network, such as using RRC signaling.

Thus, in this example, the learning model 705 may be used to determine the probability of success or failure for performing the autonomous PUSCH transmission using the first CG-PUSCH configuration while the learning model 710 may be used to determine the probability of success or failure for performing the autonomous PUSCH transmission using the second CG-PUSCH configuration. The output of the learning model 705 and the learning model 710 may be provided as inputs to a joint decision function 715 (e.g., the N 2-class classifier) which makes the final decision regarding performing the autonomous PUSCH transmission (e.g., according to the various criteria defined for the joint decision function 715). For example, the output of the joint decision function 715 may include an indication of the probability of success or failure (or the final decision based on such probabilities) for performing the autonomous PUSCH transmission during the next CG-PUSCH transmission occasion using the first CG-PUSCH configuration, using the second CG-PUSCH configuration, or deferring the autonomous PUSCH transmission until the next CG-PUSCH transmission occasion (e.g., the second CG-PUSCH transmission occasion).

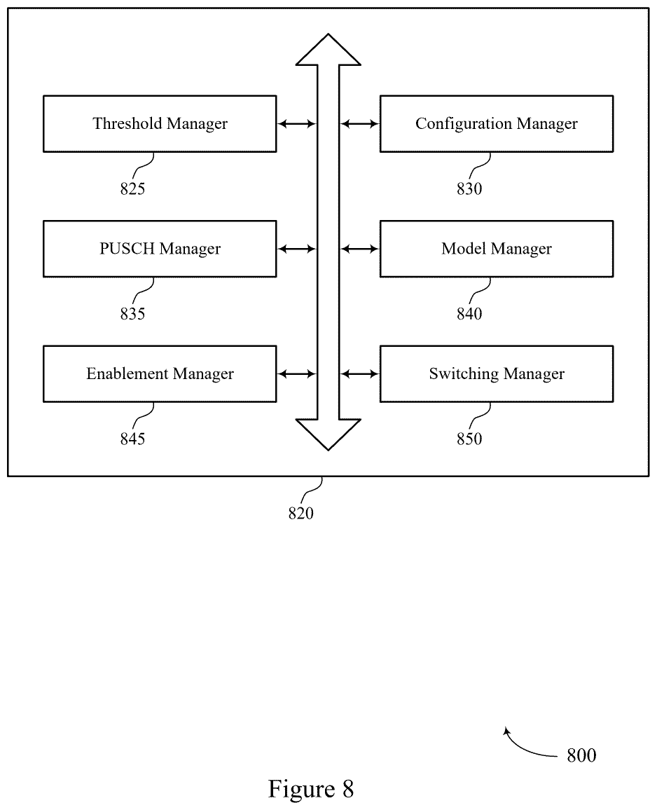

FIG. 8 shows an example 800 of a processing system 820 that supports UE autonomous uplink transmission based on AI/ML modeling. A processing system 820 may be an example of a processing system 140 (such as of a UE 115) and may include a threshold manager 825, a configuration manager 830, an PUSCH manager 835, a model manager 840, an enablement manager 845, a switching manager 850, or any combination thereof. A processing system 820, or various component thereof, may be an example of means for performing (such as a means for causing a UE 115 to perform) various techniques described herein.

The threshold manager 825 may be configured to cause the UE 115 to receive information that identifies a threshold level corresponding to a probability of success for an autonomous PUSCH transmission by the UE. The configuration manager 830 may be configured to cause the UE 115 to receive a configuration signal that identifies one or more CG-PUSCH configurations, each CG-PUSCH configuration including a set of CG-PUSCH transmission occasions available for performing autonomous PUSCH transmissions by the UE. The PUSCH manager 835 may be configured to cause the UE 115 to transmit at least one autonomous PUSCH transmission during a first CG-PUSCH transmission occasion or during a second CG-PUSCH transmission occasion based on the threshold level and the probability of success associated with the first CG-PUSCH transmission occasion.

In some examples, the model manager 840 may be configured to cause the UE 115 to apply a learning model to determine the probability of success associated with the first CG-PUSCH transmission occasion, where the at least one autonomous PUSCH transmission is performed during the first CG-PUSCH transmission occasion based on an output of the learning model satisfying the threshold level or during the second CG-PUSCH transmission occasion based on the output of the learning model failing to satisfy the threshold level.

In some examples, one or more inputs to the learning model include one or more previous channel performance metrics, one or more interference metrics, a prior PUSCH transmission success rate, a prior PDSCH success rate, or any combination thereof, during a set of slots occurring prior to a slot containing the first CG-PUSCH transmission occasion. In some examples, the learning model includes at least one of a NN learning model, a CNN learning model, a RNN learning model, an AI learning model, or any combination thereof.

In some examples, the model manager 840 may be configured to cause the UE 115 to receive one or more inputs to be applied to a learning model, where the learning model is applied to determine to perform the at least one autonomous PUSCH transmission during the first CG-PUSCH transmission occasion or during the second CG-PUSCH transmission occasion. In some examples, the one or more inputs are based on a channel whitening procedure, a CIR, or any combination thereof. In some examples, the model manager 840 may be configured to cause the UE 115 to transmit a message that registers one or more learning models of the UE with a network entity.

In some examples, the enablement manager 845 may be configured to cause the UE 115 to receive a message that enables support for a learning model by the UE, where the learning model is applied to determine to perform the at least one autonomous PUSCH transmission during the first CG-PUSCH transmission occasion or during the second CG-PUSCH transmission occasion.

In some examples, the switching manager 850 may be configured to cause the UE 115 to receive a message that indicates for the UE to switch from a first learning model to a second learning model, where the first learning model or the second learning model is applied to determine to perform the at least one autonomous PUSCH transmission during the first CG-PUSCH transmission occasion or during the second CG-PUSCH transmission occasion. In some examples, the one or more CG-PUSCH configurations include a first CG-PUSCH configuration and a second CG-PUSCH configuration. In some examples, each CG-PUSCH configuration is associated with a corresponding set of CG-PUSCH transmission occasions. In some examples, the first CG-PUSCH transmission occasion is associated with the first CG-PUSCH configuration and the second CG-PUSCH transmission occasion is associated with the second CG-PUSCH configuration.

A processing system 820 may include or be a component of one or more chips, systems-on-chips (SoCs), chipsets, packages, components, or devices that individually or collectively constitute or include a processing system. A processing system 820 may interface with other components of a processing system 820. For example, operations described with reference to a processing system 820, or various components thereof, may be performed by or with other such components, including a receiver, a transmitter, a transceiver, a modem, a user interface, a modulator/demodulator, an encoder/decoder, or any combination thereof (such as of the processing system 820, coupled with the processing system 820, of a processing system 820).

By including or configuring a processing system 820 for operation in a processing system 820 as described herein, the processing system 820 may support techniques for improved Type 1 CG-PUSCH resource usage by UE. This may be based on implementation of an AI/ML NN learning model at the UE that evaluates, based on a network-configured threshold level, the probability of success or failure if the UE performs an autonomous uplink transmission during the next upcoming PUSCH transmission occasion or defers the autonomous uplink transmission to a later PUSCH transmission occasion.

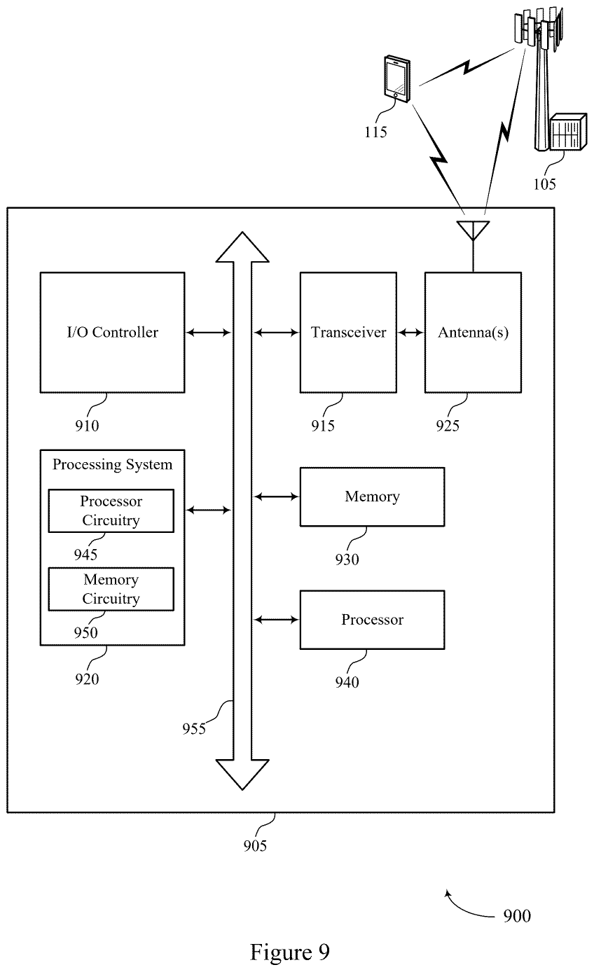

FIG. 9 shows an example of a system 900 including a device 905 that supports UE autonomous uplink transmission based on AI/ML modeling. The device 905 may be an example of or include components of UE 115. The device 905 may communicate (such as wirelessly) with one or more other devices (such as network entities 105, UEs 115). The device 905 may include components for transmitting and receiving communication, which may include a processing system 920, an input/output (I/O) controller, such as an I/O controller 910, a transceiver 915, antenna(s) 925, a memory 930, and a processor 940. Components of the device 905 may be coupled (such as operatively, communicatively, functionally, electronically, electrically, in electronic communication) a bus 955.

The transceiver 915 may support bi-directional communication via antenna(s) 925, and may support transmission operations, reception operations, or both, as described herein. The transceiver 915 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 905). The transceiver 915 may modulate symbols and provide the modulated symbols to antenna(s) 925 for transmission, and demodulate symbols from signals received using antenna(s) 925.

The processor 940 may be a general-purpose processing component that supports various operations (such as applications) of the device 905. The memory 930 may be a general-purpose storage component that stores code executable by the processor 940. Such code may include instructions that, when executed by the processor 940, cause the device 905 to perform various functions (such as to support an application of the device 905). The I/O controller 910 may manage inputs and outputs for the device 905, may manage peripherals not integrated into the device 905, or may represent a physical connection (such as port) to an external peripheral. The processor 940 may interact with a modem, a keyboard, a mouse, a touchscreen, or other device (such as via I/O controller 910). In some implementations, a user may interact with the device 905 via the I/O controller 910 or via hardware components controlled by the I/O controller 910.

The processing system 920 may be an example of a processing system 140 or a processing system 820. For example, the processing system 920 may include processor circuitry 945 and memory circuitry 950 that stores code, and may be configured to cause the device 905 to perform operations that support UE autonomous uplink transmission based on AI/ML modeling. Although the processing system 920 is illustrated as a separate component, which may involve a separate chip, chipset, or other module, in some implementations, one or more functions described with reference to the processing system 920 may be supported by or performed by a transceiver 915, antenna(s) 925, a processor 940, memory 930, or any combination thereof, such that a processing system 920 may include one or more of a transceiver 915, antenna(s) 925, a processor 940, memory 930, or any combination thereof.

By including or configuring the processing system 920 for operation in the device 905 as described herein, may support techniques for improved Type 1 CG-PUSCH resource usage by UE. This may be based on implementation of an AI/ML NN learning model at the UE that evaluates, based on a network-configured threshold level, the probability of success or failure if the UE performs an autonomous uplink transmission during the next upcoming PUSCH transmission occasion or defers the autonomous uplink transmission to a later PUSCH transmission occasion.

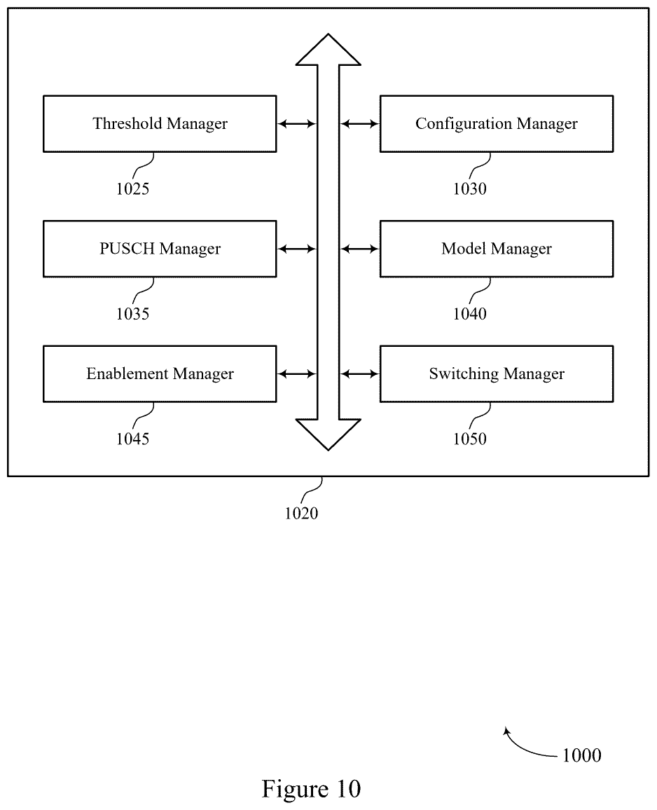

FIG. 10 shows an example 1000 of a processing system 1020 that supports UE autonomous uplink transmission based on AI/ML modeling. A processing system 1020 may be an example of a processing system 145 (such as network entity 105) and may include a threshold manager 1025, a configuration manager 1030, an PUSCH manager 1035, a model manager 1040, an enablement manager 1045, a switching manager 1050, or any combination thereof. A processing system 1020, or various component thereof, may be an example of means for performing (such as a means for causing a network entity 105 to perform) various techniques described herein.

The threshold manager 1025 may be configured to cause the network entity 105 to transmit, to a UE, information that identifies a threshold level corresponding to a probability of success for an autonomous PUSCH transmission by the UE. The configuration manager 1030 may be configured to cause the network entity 105 to transmit, to the UE, a configuration signal that identifies one or more CG-PUSCH configurations, each CG-PUSCH configuration including a set of CG-PUSCH transmission occasions available for performing autonomous PUSCH transmissions by the UE. The PUSCH manager 1035 may be configured to cause the network entity 105 to receive, from the UE, at least one autonomous PUSCH transmission during a first CG-PUSCH transmission occasion or during a second CG-PUSCH transmission occasion based on the threshold level and the probability of success associated with the first CG-PUSCH transmission occasion.

In some examples, the model manager 1040 may be configured to cause the network entity 105 to transmit, to the UE, one or more inputs to be applied to a learning model, where the learning model is applied to determine to perform the at least one autonomous PUSCH transmission during the first CG-PUSCH transmission occasion or during the second CG-PUSCH transmission occasion. In some examples, the one or more inputs are based on a channel whitening procedure, a CIR, or any combination thereof. In some examples, the model manager 1040 may be configured to cause the network entity 105 to receive, from the UE, a message that registers one or more learning models of the UE with a network entity.

In some examples, the enablement manager 1045 may be configured to cause the network entity 105 to transmit, to the UE, a message that enables support for a learning model by the UE, where the learning model is applied to determine to perform the at least one autonomous PUSCH transmission during the first CG-PUSCH transmission occasion or during the second CG-PUSCH transmission occasion.

In some examples, the switching manager 1050 may be configured to cause the network entity 105 to transmit, to the UE, a message that indicates for the UE to switch from a first learning model to a second learning model, where the first learning model or the second learning model is applied to determine to perform the at least one autonomous PUSCH transmission during the first CG-PUSCH transmission occasion or during the second CG-PUSCH transmission occasion. In some examples, the one or more CG-PUSCH configurations include a first CG-PUSCH configuration and a second CG-PUSCH configuration. In some examples, each CG-PUSCH configuration is associated with a corresponding set of CG-PUSCH transmission occasions. In some examples, the first CG-PUSCH transmission occasion is associated with the first CG-PUSCH configuration and the second CG-PUSCH transmission occasion is associated with the second CG-PUSCH configuration.

A processing system 1020 may include or be an example of one or more chips, SoCs, chipsets, packages, components, or devices that individually or collectively constitute or include a processing system. A processing system 1020 may interface with other components of a network entity 105. For example, operations described with reference to a processing system 1020, or various components thereof, may be performed by or with other such components, including a receiver, a transmitter, a transceiver, a modem, a user interface, a modulator/demodulator, an encoder/decoder, or any combination thereof (such as of the processing system 1020, coupled with the processing system 1020, of a network entity 105). Operations described herein with reference to the processing system 1020, or various components thereof, may be performed by or with other such components, including a CU 160, a DU 165, an RU 170, or any combination thereof. Each of one or more of any of such components, or subcomponents thereof (such as one or more processors, one or more memories), may communicate, directly or indirectly, with one another. The communication may include communication within a protocol layer of a protocol stack, communication associated with a logical channel of a protocol stack (such as between protocol layers of a protocol stack, within a device, component, or virtualized component associated with a network entity 105, between devices, components, or virtualized components associated with a network entity 105), or any combination thereof.

By including or configuring a processing system 1020 for operation in a processing system 1020 as described herein, the processing system 1020 may support techniques for improved Type 1 CG-PUSCH resource usage by UE. This may be based on implementation of an AI/ML NN learning model at the UE that evaluates, based on a network-configured threshold level, the probability of success or failure if the UE performs an autonomous uplink transmission during the next upcoming PUSCH transmission occasion or defers the autonomous uplink transmission to a later PUSCH transmission occasion.

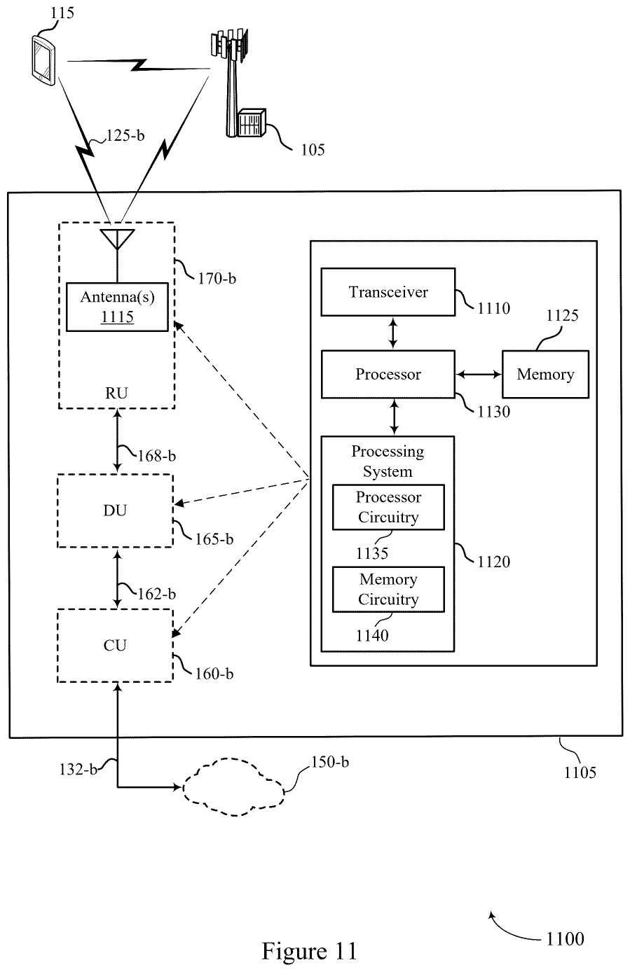

FIG. 11 shows an example of a system 1100 including a device 1105 that supports UE autonomous uplink transmission based on AI/ML modeling. The device 1105 may communicate (such as via one or more wired interfaces or one or more wireless interfaces) with other network devices or network equipment such as a core network 150-b, other network entities 105, UEs 115, or any combination thereof. The device 1105 may include components for transmitting and receiving communication, which may include a processing system 1120, a transceiver 1110, antenna(s) 1115, a memory 1125, and a processor 1130. Components of the device 1105 may be coupled (such as operatively, communicatively, functionally, electronically, electrically, in electronic communication) via one or more interfaces.

The transceiver 1110 may communicate bi-directionally with another transceiver via wired or wireless links, and may support transmission operations, reception operations, or both, as described herein. The transceiver 1110 may include a modem to modulate and demodulate signals, to provide the modulated signals for transmission (such as via antenna(s) 1115, via a wired interface), and to demodulate received signals (such as received via antenna(s) 1115, received via a wired interface). The transceiver 1110 may be operable to support communication via one or more communication links (such as a communication link 125-b, a backhaul link 132-b, a midhaul link 162-b, fronthaul link 168-b).

The processor 1130 may be a general-purpose processing component that supports various operations (such as applications) of the device 1105. The memory 1125 may be a general-purpose storage component that stores code executable by the processor 1130. Such code may include instructions that, when executed by the processor 1130, cause the device 1105 to perform various functions (such as to support an application of the device 1105).

For examples in which the device 1105 is a network entity 105 in a disaggregated architecture, one or more components of the device 1105 may be located at one or more of a CU 160-b, a DU 165-b, or an RU 170-b, one or more of which may include aspects of the processing system 1120, the processor 1130, the memory 1125, or the transceiver 1110. Functions of the device 1105 may be performed at different components or an operation may be divided between different components (such as different functions being supported by aspects of the CU 160-b, the DU 165-b, or the RU 170-b, the transceiver 1110, the processor 1130, the memory 1125, the processing system 1120, or any combination thereof). For example, the processing system 1120 may be a component of one or more of the CU 160-b, the DU 165-b, or the RU 170-b. In some examples, interfaces between components of device 1105 (such as CU 160-b, DU 165-b, RU 170-b) may support communication at a protocol layer or between protocol layers of a protocol stack.

In some examples, the processing system 1120 may manage aspects of communication with the core network 150-b (such as via a backhaul link 132). For example, the processing system 1120 may manage the transfer of data communication for UEs 115 with a gateway of the core network 150-b. In some examples, the processing system 1120 may manage communication with one or more other network entities 105 and may include a controller or scheduler for controlling communication with UEs 115 (such as in cooperation with the one or more other network entities 105). In some examples, the processing system 1120 may support an interface (such as X2 interface, Xn interface) to provide communication between network entities 105.

The processing system 1120 may be an example of a processing system 145 or a processing system 1020. For example, the processing system 1120 may include processor circuitry 1135 and memory circuitry 1140 that stores code, and the processing system 1120 may be configured to cause the device 1105 to perform operations that support UE autonomous uplink transmission based on AI/ML modeling. Although the processing system 1120 is illustrated as a separate component, which may involve a separate chip, chipset, or other module, in some implementations, one or more functions described with reference to the processing system 1120 may be supported by or performed by a transceiver 1110, antenna(s) 1115, a processor 1130, memory 1125, or any combination thereof, such that a processing system 1120 may include one or more of a transceiver 1110, antenna(s) 1115, a processor 1130, memory 1125, or any combination thereof. Further, processor circuitry 1135 and memory circuitry 1140 each may be implemented at the device 1105 in accordance with an aggregated architecture, or the processor circuitry 1135 and the memory circuitry 1140 may be implemented at one or more of a CU 160-b, a DU 165-b, or an RU 170-b in accordance with a disaggregated architecture.

By including or configuring the processing system 1120 for operation in the device 1105 as described herein, may support techniques for improved Type 1 CG-PUSCH resource usage by UE. This may be based on implementation of an AI/ML NN learning model at the UE that evaluates, based on a network-configured threshold level, the probability of success or failure if the UE performs an autonomous uplink transmission during the next upcoming PUSCH transmission occasion or defers the autonomous uplink transmission to a later PUSCH transmission occasion.

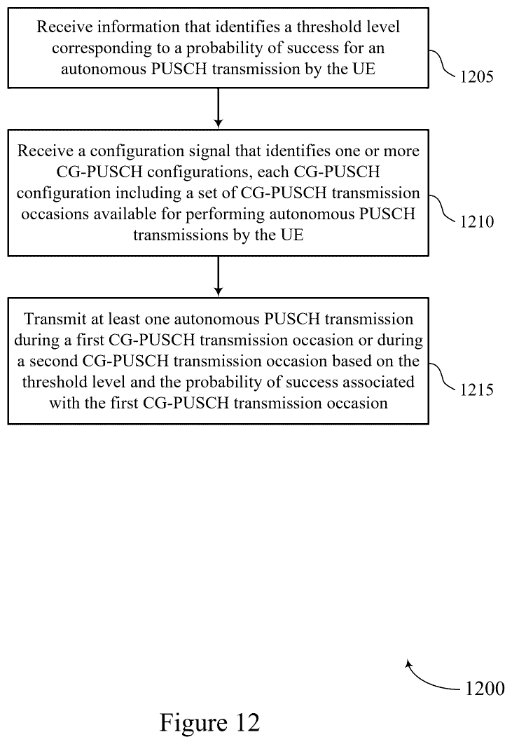

FIG. 12 shows an example of a method 1200 that supports UE autonomous uplink transmission based on AI/ML modeling. Operations of the method 1200 may be performed by a UE or its components (such as using a processing system configured to cause the UE 115 to perform one or more of the operations) as described herein.

At 1205, the method may include receiving information that identifies a threshold level corresponding to a probability of success for an autonomous PUSCH transmission by the UE. In some examples, aspects of the operations of 1205 may be performed by a threshold manager 825.

At 1210, the method may include receiving a configuration signal that identifies one or more CG-PUSCH configurations, each CG-PUSCH configuration including a set of CG-PUSCH transmission occasions available for performing autonomous PUSCH transmissions by the UE. In some examples, aspects of the operations of 1210 may be performed by a configuration manager 830.

At 1215, the method may include transmitting at least one autonomous PUSCH transmission during a first CG-PUSCH transmission occasion or during a second CG-PUSCH transmission occasion based on the threshold level and the probability of success associated with the first CG-PUSCH transmission occasion. In some examples, aspects of the operations of 1215 may be performed by an PUSCH manager 835.

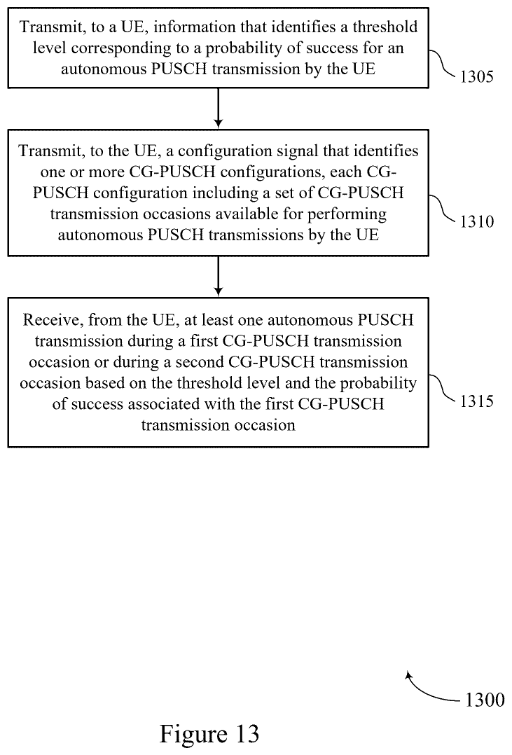

FIG. 13 shows an example of a method 1300 that supports UE autonomous uplink transmission based on AI/ML modeling. Operations of the method 1300 may be performed by a network entity 105 or its components (such as using a processing system configured to cause the network entity to perform one or more operations) as described herein.

At 1305, the method may include transmitting, to a UE, information that identifies a threshold level corresponding to a probability of success for an autonomous PUSCH transmission by the UE. In some examples, aspects of the operations of 1305 may be performed by a threshold manager 1025.

At 1310, the method may include transmitting, to the UE, a configuration signal that identifies one or more CG-PUSCH configurations, each CG-PUSCH configuration including a set of CG-PUSCH transmission occasions available for performing autonomous PUSCH transmissions by the UE. In some examples, aspects of the operations of 1310 may be performed by a configuration manager 1030.

At 1315, the method may include receiving, from the UE, at least one autonomous PUSCH transmission during a first CG-PUSCH transmission occasion or during a second CG-PUSCH transmission occasion based on the threshold level and the probability of success associated with the first CG-PUSCH transmission occasion. In some examples, aspects of the operations of 1315 may be performed by an PUSCH manager 1035.

Implementation examples are described in the following numbered clauses:
Aspect 1: A method for wireless communications at a UE, comprising: receiving information that identifies a threshold level corresponding to a probability of success for an autonomous PUSCH transmission by the UE; receiving a configuration signal that identifies one or more CG-PUSCH configurations, each CG-PUSCH configuration comprising a set of CG-PUSCH transmission occasions available for performing autonomous PUSCH transmissions by the UE; and transmitting at least one autonomous PUSCH transmission during a first CG-PUSCH transmission occasion or during a second CG-PUSCH transmission occasion based at least in part on the threshold level and the probability of success associated with the first CG-PUSCH transmission occasion.
Aspect 2: The method of aspect 1, further comprising: applying a learning model to determine the probability of success associated with the first CG-PUSCH transmission occasion, wherein the at least one autonomous PUSCH transmission is performed during the first CG-PUSCH transmission occasion based on an output of the learning model satisfying the threshold level or during the second CG-PUSCH transmission occasion based on the output of the learning model failing to satisfy the threshold level.
Aspect 3: The method of aspect 2, wherein one or more inputs to the learning model comprise one or more previous channel performance metrics, one or more interference metrics, a prior PUSCH transmission success rate, a prior PDSCH success rate, or any combination thereof, during a set of slots occurring prior to a slot containing the first CG-PUSCH transmission occasion.
Aspect 4: The method of any of aspects 2 through 3, wherein the learning model comprises at least one of a NN learning model, a CNN learning model, a RNN learning model, an AI learning model, or any combination thereof.
Aspect 5: The method of any of aspects 1 through 4, further comprising: receiving one or more inputs to be applied to a learning model, wherein the learning model is applied to determine to perform the at least one autonomous PUSCH transmission during the first CG-PUSCH transmission occasion or during the second CG-PUSCH transmission occasion.
Aspect 6: The method of aspect 5, wherein the one or more inputs are based at least in part on a channel whitening procedure, a CIR, or any combination thereof.
Aspect 7: The method of any of aspects 1 through 6, further comprising: transmitting a message that registers one or more learning models of the UE with a network entity.
Aspect 8: The method of any of aspects 1 through 7, further comprising: receiving a message that enables support for a learning model by the UE, wherein the learning model is applied to determine to perform the at least one autonomous PUSCH transmission during the first CG-PUSCH transmission occasion or during the second CG-PUSCH transmission occasion.
Aspect 9: The method of any of aspects 1 through 8, further comprising: receiving a message that indicates for the UE to switch from a first learning model to a second learning model, wherein the first learning model or the second learning model is applied to determine to perform the at least one autonomous PUSCH transmission during the first CG-PUSCH transmission occasion or during the second CG-PUSCH transmission occasion.
Aspect 10: The method of any of aspects 1 through 9, wherein the one or more CG-PUSCH configurations comprise a first CG-PUSCH configuration and a second CG-PUSCH configuration, and each CG-PUSCH configuration is associated with a corresponding set of CG-PUSCH transmission occasions.
Aspect 11: The method of aspect 10, wherein the first CG-PUSCH transmission occasion is associated with the first CG-PUSCH configuration and the second CG-PUSCH transmission occasion is associated with the second CG-PUSCH configuration.
Aspect 12: A method for wireless communications at a network entity, comprising: transmitting, to a UE, information that identifies a threshold level corresponding to a probability of success for an autonomous PUSCH transmission by the UE; transmitting, to the UE, a configuration signal that identifies one or more CG-PUSCH configurations, each CG-PUSCH configuration comprising a set of CG-PUSCH transmission occasions available for performing autonomous PUSCH transmissions by the UE; and receiving, from the UE, at least one autonomous PUSCH transmission during a first CG-PUSCH transmission occasion or during a second CG-PUSCH transmission occasion based at least in part on the threshold level and the probability of success associated with the first CG-PUSCH transmission occasion.
Aspect 13: The method of aspect 12, further comprising: transmitting, to the UE, one or more inputs to be applied to a learning model, wherein the learning model is applied to determine to perform the at least one autonomous PUSCH transmission during the first CG-PUSCH transmission occasion or during the second CG-PUSCH transmission occasion.
Aspect 14: The method of aspect 13, wherein the one or more inputs are based at least in part on a channel whitening procedure, a CIR, or any combination thereof.
Aspect 15: The method of any of aspects 12 through 14, further comprising: receiving, from the UE, a message that registers one or more learning models of the UE with a network entity.
Aspect 16: The method of any of aspects 12 through 15, further comprising: transmitting, to the UE, a message that enables support for a learning model by the UE, wherein the learning model is applied to determine to perform the at least one autonomous PUSCH transmission during the first CG-PUSCH transmission occasion or during the second CG-PUSCH transmission occasion.
Aspect 17: The method of any of aspects 12 through 16, further comprising: transmitting, to the UE, a message that indicates for the UE to switch from a first learning model to a second learning model, wherein the first learning model or the second learning model is applied to determine to perform the at least one autonomous PUSCH transmission during the first CG-PUSCH transmission occasion or during the second CG-PUSCH transmission occasion.
Aspect 18: The method of any of aspects 12 through 17, wherein the one or more CG-PUSCH configurations comprise a first CG-PUSCH configuration and a second CG-PUSCH configuration, and each CG-PUSCH configuration is associated with a corresponding set of CG-PUSCH transmission occasions.
Aspect 19: The method of aspect 18, wherein the first CG-PUSCH transmission occasion is associated with the first CG-PUSCH configuration and the second CG-PUSCH transmission occasion is associated with the second CG-PUSCH configuration.
Aspect 20: A UE for wireless communications, comprising a processing system that includes processor circuitry and memory circuitry that stores code, the processing system configured to cause the UE to perform a method of any of aspects 1 through 11.
Aspect 21: A UE for wireless communications, comprising at least one means for performing a method of any of aspects 1 through 11.
Aspect 22: A non-transitory computer-readable medium storing code for wireless communications, the code comprising instructions executable by one or more processors to perform a method of any of aspects 1 through 11.
Aspect 23: A network entity for wireless communications, comprising a processing system that includes processor circuitry and memory circuitry that stores code, the processing system configured to cause the network entity to perform a method of any of aspects 12 through 19.
Aspect 24: A network entity for wireless communications, comprising at least one means for performing a method of any of aspects 12 through 19.
Aspect 25: A non-transitory computer-readable medium storing code for wireless communications, the code comprising instructions executable by one or more processors to perform a method of any of aspects 12 through 19.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive information that identifies a threshold level corresponding to a probability of success for an autonomous physical uplink shared channel (PUSCH) transmission by the UE;
receive a configuration signal that identifies one or more configured grant (CG)-PUSCH configurations, each CG-PUSCH configuration comprising a set of CG-PUSCH transmission occasions available for performing autonomous PUSCH transmissions by the UE; and
transmit at least one autonomous PUSCH transmission during a first CG-PUSCH transmission occasion or during a second CG-PUSCH transmission occasion based at least in part on the threshold level and the probability of success associated with the first CG-PUSCH transmission occasion.

2. The UE of claim 1, wherein the one or more processors are individually or collectively further operable to execute the code to cause the UE to:
apply a learning model to determine the probability of success associated with the first CG-PUSCH transmission occasion, wherein the at least one autonomous PUSCH transmission is performed during the first CG-PUSCH transmission occasion based on an output of the learning model satisfying the threshold level or during the second CG-PUSCH transmission occasion based on the output of the learning model failing to satisfy the threshold level.

3. The UE of claim 2, wherein one or more inputs to the learning model comprise one or more previous channel performance metrics, one or more interference metrics, a prior PUSCH transmission success rate, a prior physical downlink shared channel (PDSCH) success rate, or any combination thereof, during a set of slots occurring prior to a slot containing the first CG-PUSCH transmission occasion.

4. The UE of claim 2, wherein the learning model comprises at least one of a neural network (NN) learning model, a convolution NN (CNN) learning model, a recurrent NN (RNN) learning model, an artificial intelligence (AI) learning model, or any combination thereof.

5. The UE of claim 1, wherein the one or more processors are individually or collectively further operable to execute the code to cause the UE to:
receive one or more inputs to be applied to a learning model, wherein the learning model is applied to determine to perform the at least one autonomous PUSCH transmission during the first CG-PUSCH transmission occasion or during the second CG-PUSCH transmission occasion.

6. The UE of claim 5, wherein the one or more inputs are based at least in part on a channel whitening procedure, a channel impulse response (CIR), or any combination thereof.

7. The UE of claim 1, wherein the one or more processors are individually or collectively further operable to execute the code to cause the UE to:
transmit a message that registers one or more learning models of the UE with a network entity.

8. The UE of claim 1, wherein the one or more processors are individually or collectively further operable to execute the code to cause the UE to:
receive a message that enables support for a learning model by the UE, wherein the learning model is applied to determine to perform the at least one autonomous PUSCH transmission during the first CG-PUSCH transmission occasion or during the second CG-PUSCH transmission occasion.

9. The UE of claim 1, wherein the one or more processors are individually or collectively further operable to execute the code to cause the UE to:
receive a message that indicates for the UE to switch from a first learning model to a second learning model, wherein the first learning model or the second learning model is applied to determine to perform the at least one autonomous PUSCH transmission during the first CG-PUSCH transmission occasion or during the second CG-PUSCH transmission occasion.

10. The UE of claim 1, wherein:
the one or more CG-PUSCH configurations comprise a first CG-PUSCH configuration and a second CG-PUSCH configuration, and
each CG-PUSCH configuration is associated with a corresponding set of CG-PUSCH transmission occasions.

11. The UE of claim 10, wherein the first CG-PUSCH transmission occasion is associated with the first CG-PUSCH configuration and the second CG-PUSCH transmission occasion is associated with the second CG-PUSCH configuration.

12. A network entity, comprising:
one or more memories storing processor-executable code; and
one or more processors coupled with the one or more memories and individually or collectively operable to execute the code to cause the network entity to:
transmit, to a user equipment (UE), information that identifies a threshold level corresponding to a probability of success for an autonomous physical uplink shared channel (PUSCH) transmission by the UE;
transmit, to the UE, a configuration signal that identifies one or more configured grant (CG)-PUSCH configurations, each CG-PUSCH configuration comprising a set of CG-PUSCH transmission occasions available for performing autonomous PUSCH transmissions by the UE; and
receive, from the UE, at least one autonomous PUSCH transmission during a first CG-PUSCH transmission occasion or during a second CG-PUSCH transmission occasion based at least in part on the threshold level and the probability of success associated with the first CG-PUSCH transmission occasion.

13. The network entity of claim 12, wherein the one or more processors are individually or collectively further operable to execute the code to cause the network entity to:
transmit, to the UE, one or more inputs to be applied to a learning model, wherein the learning model is applied to determine to perform the at least one autonomous PUSCH transmission during the first CG-PUSCH transmission occasion or during the second CG-PUSCH transmission occasion.

14. The network entity of claim 13, wherein the one or more inputs are based at least in part on a channel whitening procedure, a channel impulse response (CIR), or any combination thereof.

15. The network entity of claim 12, wherein the one or more processors are individually or collectively further operable to execute the code to cause the network entity to:
receive, from the UE, a message that registers one or more learning models of the UE with a network entity.

16. The network entity of claim 12, wherein the one or more processors are individually or collectively further operable to execute the code to cause the network entity to:
transmit, to the UE, a message that enables support for a learning model by the UE, wherein the learning model is applied to determine to perform the at least one autonomous PUSCH transmission during the first CG-PUSCH transmission occasion or during the second CG-PUSCH transmission occasion.

17. The network entity of claim 12, wherein the one or more processors are individually or collectively further operable to execute the code to cause the network entity to:
transmit, to the UE, a message that indicates for the UE to switch from a first learning model to a second learning model, wherein the first learning model or the second learning model is applied to determine to perform the at least one autonomous PUSCH transmission during the first CG-PUSCH transmission occasion or during the second CG-PUSCH transmission occasion.

18. The network entity of claim 12, wherein:
the one or more CG-PUSCH configurations comprise a first CG-PUSCH configuration and a second CG-PUSCH configuration, and
each CG-PUSCH configuration is associated with a corresponding set of CG-PUSCH transmission occasions.

19. The network entity of claim 18, wherein the first CG-PUSCH transmission occasion is associated with the first CG-PUSCH configuration and the second CG-PUSCH transmission occasion is associated with the second CG-PUSCH configuration.

20. A method for wireless communications at a user equipment (UE), comprising:
receiving information that identifies a threshold level corresponding to a probability of success for an autonomous physical uplink shared channel (PUSCH) transmission by the UE;
receiving a configuration signal that identifies one or more configured grant (CG)-PUSCH configurations, each CG-PUSCH configuration comprising a set of CG-PUSCH transmission occasions available for performing autonomous PUSCH transmissions by the UE; and
transmitting at least one autonomous PUSCH transmission during a first CG-PUSCH transmission occasion or during a second CG-PUSCH transmission occasion based at least in part on the threshold level and the probability of success associated with the first CG-PUSCH transmission occasion.
